(19) United States
(12) Patent Application Publication
(10) Pub. No.: US 2024/0009806 A1
(43) Pub. Date: Jan. 11, 2024

(54) THRUST REDUCTION SYSTEM FOR A BLAST NOZZLE

(71) Applicant: BLASTONE TECHNOLOGY PTY LTD, Murarrie, Queensland (AU)

(72) Inventors: Matthew David Campbell ROWLAND, Camberwell (AU); Trevor Andrew SEEWALD, Upper Kedron (AU); Ingo Johannes Henri JAHN, Upper Brookfield (AU); Phillip Bradley SWANN, Redbank Plains (AU)

(21) Appl. No.: 18/039,702

(22) PCT Filed: Dec. 2, 2021
(86) PCT No.: PCT/AU2021/051438

§ 371 Date: May 31, 2023

Related U.S. Application Data
(60) Provisional application No. 63/220,153, filed on Jul. 9, 2021.
(60) Provisional application No. 63/120,418, filed on Dec. 2, 2020.

(30) Foreign Application Priority Data
Dec. 2, 2020 (AU) 2020904468
Jul. 9, 2021 (AU) 2021902119

(51) Int. Cl. B24C 5/04

(52) U.S. Cl. CPC B24C 5/04; B05B 7/1486

(57) ABSTRACT

A blast nozzle thrust reduction blasting system comprising:

a source of blasting gas in a predetermined pressure range with abrasive particles entrained therein;

a nozzle including
a nozzle inlet for connection to the source of blasting gas,
a nozzle outlet for emission of the blasting gas,
a nozzle conduit from the nozzle inlet to the nozzle outlet including a throat therebetween with a ratio of area of the nozzle outlet to area of the throat selected to emit the blasting gas from the nozzle outlet to produce a supersonic jet;

a thrust reducer connectable to the nozzle, to receive the supersonic jet exiting the nozzle, the thrust reducer comprising a body with a thrust reducer conduit therethrough, the body being of sufficient length and diameter to cause a flow condition of the jet received from the nozzle outlet to be modified such that a zone of sub-atmospheric pressure forms adjacent a face of the outlet of the nozzle whereby a pressure differential arises between the zone of sub-atmospheric pressure and surrounding atmosphere thereby creating an anti-thrust force in opposition to thrust of the nozzle.

### FIELD

The present disclosure relates to a thrust reduction system for reducing thrust produced by a blast nozzle during pneumatic blasting.

### BACKGROUND

Any references to methods, apparatus or documents of the prior art are not to be taken as constituting any evidence or admission that they formed, or form, part of the common general knowledge.

It is known to provide a blasting apparatus in which particles of abrasive material entrained in a stream of pressurised gas, most usually air, are expelled from a nozzle in a high velocity jet of the air that is directed onto a surface in order that the particles forcibly impact the surface to clean and/or abrade the surface.

One historically used abrasive material is sand, and when sand is used the blasting process may be referred to as sand blasting. However, other abrasive materials may be used, and garnet is often preferred to silica sand.

The nozzle used as part of the blasting apparatus comprises a body of hardwearing material through which a conduit for the stream of pressurised gas is formed. Commonly, the conduit is shaped so that the nozzles are comprised of a converging inlet portion, which includes an inlet opening for coupling to a source of the pressurised gas such as a blast pot. The inlet portion converges to a throat from which an outlet portion of the conduit extends to a nozzle outlet. The convergence of the inlet portion to the throat raises the velocity of the pressurised gas to approximately sonic speeds. The outlet portion may be formed to diverge from the throat to the nozzle outlet in order to further increase the velocity of the air so that the jet that is emitted from the nozzle outlet is at a high velocity.

FIG. 1 depicts a conventional blasting nozzle 1 in use. The blasting nozzle 1 is coupled by a connector 3 to a hose 5 through which high pressure air 6 containing abrasive particles is passed to an inlet 7 of the nozzle 1 from a blast pot 2. The nozzle 1 is formed with an internal, longitudinal conduit 9 that includes an inlet portion 10 which converges from an inlet 7 to an axially extending throat 12, from which a diverging outlet portion 14 extends to nozzle outlet 11. The conduit 9 is thus shaped to accelerate the air so that the air is emitted from the nozzle outlet 11 in a high velocity jet 13 that is directed against a surface 15 of a workpiece 17 that is cleaned and 5 abraded by the abrasive particles in the jet 13.

The high pressure and air flows used in abrasive blasting produce thrust, indicated by arrows 4 in the opposite direction to the flow of the blast stream, being the jet 13. The force of this blast nozzle thrust 4, sometimes referred to as nozzle kick back, varies depending on nozzle size, such as nozzle 1, and inlet pressure and can range from around 6 kg for a No. 6 nozzle to more than 17 kg for a No. 10 nozzle when operated at an inlet pressure of 100 psi. Operators, i.e. the worker who holds the nozzle 1, are required to resist the blast nozzle thrust 4 during blasting processes, which can lead to operator fatigue, reduced productivity and stress related injuries due to extended use.

Blast nozzle thrust is inherent with the operation of all blast nozzles. The reduction of blast nozzle thrust has not been adequately addressed and remains problematic for blasting operators and the industry more broadly.

It is an object of the present disclosure to provide method and apparatus for reducing blast nozzle thrust.

### SUMMARY

In one aspect there is provided a blast nozzle blast thrust reduction apparatus for connection to a blast nozzle, including a body defining a conduit extending from an inlet of the thrust reduction apparatus to an outlet of the thrust reduction apparatus, the body being of a diameter and length for the conduit to extend a distance from an outlet of the blast nozzle sufficient to reduce the nozzle thrust produced by the jet emitted from the blast nozzle outlet in use.

In an aspect there is provided a blast nozzle thrust reduction blasting system comprising:
a source of blasting gas in a predetermined pressure range with abrasive particles entrained therein;
a nozzle including
   a nozzle inlet for connection to the source of blasting gas,
   a nozzle outlet for emission of the blasting gas,
   a nozzle conduit from the nozzle inlet to the nozzle outlet including a throat therebetween with a ratio of area of the nozzle outlet to area of the throat selected to emit the blasting gas from the nozzle outlet to produce a supersonic jet;
a thrust reducer connectable to the nozzle, to receive the supersonic jet exiting the nozzle, the thrust reducer comprising a body with a thrust reducer conduit therethrough, the body being of sufficient length and diameter to cause a flow condition of the jet received from the nozzle outlet to be modified such that a zone of sub-atmospheric pressure forms adjacent a face of the outlet of the nozzle whereby a pressure differential arises between the zone of sub-atmospheric pressure and surrounding atmosphere thereby creating an anti-thrust force in opposition to thrust of the nozzle.

In an embodiment the thrust reducer body includes a coupling portion arranged to connect to a portion of the nozzle adjacent the nozzle outlet and a thrust reduction portion defining the thrust reducer conduit, wherein the thrust reduction portion extends from the coupling portion to a thrust reducer outlet of the thrust reducer.

In an embodiment the predetermined pressure range is 80 psi or greater.

In an embodiment the nozzle has a nozzle exit area to nozzle throat area ratio (A/A*) of 1.63±5%.

In an embodiment the nozzle comprises a #3 nozzle and the thrust reducer has a thrust reducer outlet diameter of 11.75±2.5% mm and a thrust reduction portion length of 37.50±5% mm.

In an embodiment the nozzle comprises a #4 nozzle and the thrust reducer has a thrust reducer outlet diameter of 15.67±2.5% mm and a thrust reduction portion length of 50.00±5% mm.

In an embodiment the nozzle comprises a #5 nozzle and the thrust reducer has a thrust reducer outlet diameter of 19.58±2.5% mm and a thrust reduction portion length of 62.50±5% mm.

In an embodiment the nozzle comprises a #6 nozzle and the thrust reducer has a thrust reducer outlet diameter of 23.50±2.5% mm and a thrust reduction portion length of 75.00±5% mm.

In an embodiment the nozzle comprises a #7 nozzle and the thrust reducer has a thrust reducer outlet diameter of 27.1±2.5% mm and a thrust reduction portion length of 87.50±5% mm.

In an embodiment the nozzle comprises a #8 and the thrust reducer has a thrust reducer outlet diameter of 31.33±2.5% mm and a thrust reduction portion length of 100±5% mm.

In an embodiment the nozzle comprises a #10 nozzle and the thrust reducer has a thrust reducer outlet diameter of 39.16±2.5% mm and a thrust reduction portion length of 125±5% mm.

In an embodiment the nozzle comprises a nozzle with nozzle size as set out in the leftmost column of the following table and the thrust reducer has a thrust reducer outlet diameter as set out in the following table for the nozzle size and thrust reduction portion length at least as long as set out in the following table for the nozzle size:

| Nozzle | Thrust reduction | Outlet |
|---|---|---|
| Size | portion length (mm) | Diameter (mm) |
| No. 3 | 67.5 | 13.5 |
| No. 4 | 90.0 | 18.0 |
| No. 5 | 112.5 | 22.5 |
| No. 6 | 135.0 | 27.1 |
| No. 7 | 157.5 | 31.5 |
| No. 8 | 179.5 | 36.0 |
| No. 10 | 224.5 | 45.0 |

In an embodiment the nozzle comprises a nozzle with nozzle size as set out in the leftmost column of the following table and the thrust reducer has a thrust reducer outlet diameter as set out in the following table for the nozzle size and thrust reduction portion length at least as long as set out in the following table for the nozzle size:

| Nozzle | Thrust reduction | Outlet |
|---|---|---|
| Size | portion length (mm) | Diameter (mm) |
| No. 3 | 17.5 | 10.0 |
| No. 4 | 23.0 | 13.0 |
| No. 5 | 29.0 | 16.5 |
| No. 6 | 34.5 | 20.0 |
| No. 7 | 40.5 | 23.0 |
| No. 8 | 46.0 | 26.5 |
| No. 10 | 57.5 | 33.0 |

In an embodiment the nozzle has a nozzle exit area to nozzle throat area ratio (A/A*) of 1.42±5%

In an embodiment the nozzle comprises a nozzle with a nozzle size as set out in the leftmost column of the following table and the thrust reducer has a thrust reducer outlet diameter as set out in the following table for the nozzle size and thrust reduction portion length at least as long as set out in the following table for the nozzle size:

| Nozzle | Outlet | Thrust reduction |
|---|---|---|
| Size | Diameter (mm) | portion length (mm) |
| No. 3 | 10.95 | 18.0 |
| No. 4 | 14.60 | 24.0 |
| No. 5 | 18.26 | 30.0 |
| No. 6 | 21.91 | 36.0 |
| No. 7 | 25.56 | 42.0 |
| No. 8 | 29.21 | 48.0 |
| No. 10 | 36.51 | 60.0 |

In an embodiment the nozzle has a nozzle exit area to nozzle throat area ratio (A/A*) of 2.1±5%.

In an embodiment the nozzle comprises a nozzle with a nozzle size as set out in the leftmost column of the following table and the thrust reducer has a thrust reducer outlet diameter as set out in the following table for the nozzle size and thrust reduction portion length at least as long as set out in the following table for the nozzle size:

| Nozzle | Outlet | Thrust reduction |
|---|---|---|
| Size | Diameter (mm) | portion length (mm) |
| No. 3 | 13.32 | 78.5 |
| No. 4 | 17.76 | 104.5 |
| No. 5 | 22.20 | 130.5 |
| No. 6 | 26.64 | 157.0 |
| No. 7 | 31.08 | 183.0 |
| No. 8 | 35.52 | 209.0 |
| No. 10 | 44.40 | 261.0 |

In an embodiment the predetermined pressure range is 80 psi or greater and the nozzle has an A/A* area ratio of 1.63±5% wherein the nozzle comprises a nozzle with a nozzle size as set out in the leftmost column of the following table and the thrust reducer has a thrust reducer outlet diameter as set out in the following table for the nozzle size and thrust reduction portion length ranging between the preferred length and the minimum length for effective thrust reduction as set out in the following table for the nozzle size:

| | Preferred | Preferred | Minimum Length for |
|---|---|---|---|
| Nozzle | Diameter | Length | effective thrust |
| Size | (mm) | (mm) | reduction (mm) |
| No. 3 | 11.8 | 37.5 | 23.5 |
| No. 4 | 15.7 | 50.0 | 31.0 |
| No. 5 | 19.6 | 62.5 | 39.0 |
| No. 6 | 23.5 | 75.0 | 46.5 |
| No. 7 | 27.4 | 87.5 | 54.5 |
| No. 8 | 31.3 | 100.0 | 62.0 |
| No. 10 | 39.2 | 125.0 | 77.5 |

In an embodiment the predetermined pressure range is 80 psi to 120 psi and the nozzle has an A/A* area ratio of 1.63±5% wherein the nozzle comprises a #3 nozzle and wherein the length of the thrust reducer is between 7.5 mm and 67.5 mm and the diameter of the thrust reducer is between 10.00 mm and 13.5 mm.

In an embodiment the predetermined pressure range is 80 psi to 120 psi and the nozzle has an A/A* area ratio of 1.63±5% wherein the nozzle comprises a #4 nozzle and wherein the length of the thrust reducer is between 10.0 mm and 90 mm and the diameter of the thrust reducer is between 13 mm and 18 mm.

In an embodiment the predetermined pressure range is 80 psi to 120 psi and the nozzle has an A/A* area ratio of 1.63±5% wherein the nozzle comprises a #5 nozzle and wherein the length of the thrust reducer is between 12.5 mm and 112.5 mm and the diameter of the thrust reducer is between 12.5 mm and 22.5 mm.

In an embodiment the predetermined pressure range is 80 psi to 120 psi and the nozzle has an A/A* area ratio of 1.63±5% wherein the nozzle comprises a #6 nozzle and wherein the length of the thrust reducer is between 15 mm and 135.0 mm and the diameter of the thrust reducer is between 20 mm and 27.1 mm.

In an embodiment the predetermined pressure range is 80 psi to 120 psi and the nozzle has an A/A* area ratio of 1.63±5% wherein the nozzle comprises a #7 nozzle and wherein the length of the thrust reducer is between 17.5 mm and 157.5 mm and the diameter of the thrust reducer is between 23 mm and 31.5 mm.

In an embodiment the predetermined pressure range is 80 psi to 120 psi and the nozzle has an A/A* area ratio of 1.63±5% wherein the nozzle comprises a #8 nozzle and wherein the length of the thrust reducer is between 20.0 mm and 179.5 mm and the diameter of the thrust reducer is between 26.5 mm and 36.0 mm.

In an embodiment the predetermined pressure range is 80 psi to 120 psi and the nozzle has an A/A* area ratio of 1.63±5% wherein the nozzle comprises a #10 nozzle and wherein the length of the thrust reducer is between 25 mm and 224.5 mm and the diameter of the thrust reducer is between 33.0 mm and 45.0 mm.

In an embodiment the nozzle has a nozzle exit area to nozzle throat area ratio (A/A*) of between 1.42 and 2.1 and wherein the nozzle comprises a #3 nozzle and the silencer has a silencer outlet diameter of between 10 mm and 13.6 mm and a minimum sound suppression portion length of between 7.5 mm and 78.5 mm.

In an embodiment the nozzle has a nozzle exit area to nozzle throat area ratio (A/A*) of between 1.42 and 2.1 and wherein the nozzle comprises a #4 nozzle and the silencer has a silencer outlet diameter of between 12.4 mm and 18.1 mm and a minimum sound suppression portion length of between 10 mm and 104 mm.

In an embodiment the nozzle has a nozzle exit area to nozzle throat area ratio (A/A*) of between 1.42 and 2.1 and wherein the nozzle comprises a #5 nozzle and the silencer has a silencer outlet diameter of between 15.5 mm and 22.6 mm and a minimum sound suppression portion length of between 12.5 mm and 130.5 mm.

In an embodiment the nozzle has a nozzle exit area to nozzle throat area ratio (A/A*) of between 1.42 and 2.1 and wherein the nozzle comprises a #6 nozzle and the silencer has a silencer outlet diameter of between 18.5 mm and 27.1 mm and a minimum sound suppression portion length of between 15 mm and 157 mm.

In an embodiment the nozzle has a nozzle exit area to nozzle throat area ratio (A/A*) of between 1.42 and 2.1 and wherein the nozzle comprises a #7 nozzle and the silencer has a silencer outlet diameter of between 21.7 mm and 31.6 mm and a minimum sound suppression portion length of between 17.5 mm and 183 mm.

In an embodiment the nozzle has a nozzle exit area to nozzle throat area ratio (A/A*) of between 1.42 and 2.1 and wherein the nozzle comprises a #8 nozzle and the silencer has a silencer outlet diameter of between 24.8 mm and 36.1 mm and a minimum sound suppression portion length of between 20 mm and 209 mm.

In an embodiment the nozzle has a nozzle exit area to nozzle throat area ratio (A/A*) of between 1.42 and 2.1 and wherein the nozzle comprises a #10 nozzle and the silencer has a silencer outlet diameter of between 31.0 mm and 45.2 mm and a minimum sound suppression portion length of between 25 mm and 261 mm.

In an embodiment the coupling portion comprises a female thread.

In an embodiment the thrust reducer body includes an inlet body portion that is removably received within the thrust reducer conduit of the thrust reducer body.

In an embodiment the inlet body portion comprises a removable sleeve that is removably received within the body.

In another aspect there is provided a method for reducing blast nozzle thrust of a blast nozzle, the method comprising:
providing a blast nozzle including a nozzle body with a nozzle conduit extending from a nozzle inlet to a nozzle outlet with a throat of the conduit therebetween, a ratio of outlet area to throat area constraining the nozzle to produce a supersonic jet;
connecting a source of blasting gas sufficient to produce a supersonic jet at the nozzle outlet; and
coupling a thrust reducer to an outlet end of the nozzle,
the thrust reducer comprising a body with a thrust reducer conduit therethrough, the body being of sufficient length and diameter to cause a flow condition of the jet received from the nozzle outlet to be modified such that a zone of sub-atmospheric pressure forms adjacent a face of the outlet of the nozzle whereby a pressure differential arises between the zone of sub-atmospheric pressure and surrounding atmosphere thereby creating an anti-thrust force in opposition to thrust of the nozzle.

In an embodiment the thrust reducer body includes a coupling portion arranged to connect to a portion of the nozzle adjacent the nozzle outlet and a thrust reduction portion defining the thrust reducer conduit, wherein the thrust reduction portion extends from the coupling portion to a thrust reducer outlet of the thrust reducer.

In an embodiment the predetermined pressure range is 80 psi or greater.

In an embodiment the nozzle has a nozzle exit area to nozzle throat area ratio (A/A*) of 1.63±5%.

In an embodiment the nozzle comprises a #3 nozzle and the thrust reducer has a thrust reducer outlet diameter of 11.75±2.5% mm and a thrust reduction portion length of 37.50±5% mm.

In an embodiment the nozzle comprises a #4 nozzle and the thrust reducer has a thrust reducer outlet diameter of 15.67±2.5% mm and a thrust reduction portion length of 50.00±5% mm.

In an embodiment the nozzle comprises a #5 nozzle and the thrust reducer has a thrust reducer outlet diameter of 19.58±2.5% mm and a thrust reduction portion length of 62.50±5% mm.

In an embodiment the nozzle comprises a #6 nozzle and the thrust reducer has a thrust reducer outlet diameter of 23.50±2.5% mm and a thrust reduction portion length of 75.00±5% mm.

In an embodiment the nozzle comprises a #7 nozzle and the thrust reducer has a thrust reducer outlet diameter of 27.1±2.5% mm and a thrust reduction portion length of 87.50±5% mm.

In an embodiment the nozzle comprises a #8 and the thrust reducer has a thrust reducer outlet diameter of 31.33±2.5% mm and a thrust reduction portion length of 100±5% mm.

In an embodiment the nozzle comprises a #10 nozzle and the thrust reducer has a thrust reducer outlet diameter of 39.16±2.5% mm and a thrust reduction portion length of 125±5% mm.

In an embodiment the nozzle comprises a nozzle with nozzle size as set out in the leftmost column of the following table and the thrust reducer has a thrust reducer outlet diameter as set out in the following table for the nozzle size and thrust reduction portion length at least as long as set out in the following table for the nozzle size:

| Nozzle | Thrust reduction | Outlet |
|---|---|---|
| Size | portion length (mm) | Diameter (mm) |
| No. 3 | 67.5 | 13.5 |
| No. 4 | 90.0 | 18.0 |
| No. 5 | 112.5 | 22.5 |
| No. 6 | 135.0 | 27.1 |
| No. 7 | 157.5 | 31.5 |
| No. 8 | 179.5 | 36.0 |
| No. 10 | 224.5 | 45.0 |

In an embodiment the nozzle comprises a nozzle with nozzle size as set out in the leftmost column of the following table and the thrust reducer has a thrust reducer outlet diameter as set out in the following table for the nozzle size and thrust reduction portion length at least as long as set out in the following table for the nozzle size:

| Nozzle | Thrust reduction | Outlet |
|---|---|---|
| Size | portion length (mm) | Diameter (mm) |
| No. 3 | 17.5 | 10.0 |
| No. 4 | 23.0 | 13.0 |
| No. 5 | 29.0 | 16.5 |
| No. 6 | 34.5 | 20.0 |
| No. 7 | 40.5 | 23.0 |
| No. 8 | 46.0 | 26.5 |
| No. 10 | 57.5 | 33.0 |

In an embodiment the nozzle has a nozzle exit area to nozzle throat area ratio (A/A*) of 1.42±5%

In an embodiment the nozzle comprises a nozzle with a nozzle size as set out in the leftmost column of the following table and the thrust reducer has a thrust reducer outlet diameter as set out in the following table for the nozzle size and thrust reduction portion length at least as long as set out in the following table for the nozzle size:

| Nozzle | Outlet | Thrust reduction |
|---|---|---|
| Size | Diameter (mm) | portion length (mm) |
| No. 3 | 10.95 | 18.0 |
| No. 4 | 14.60 | 24.0 |
| No. 5 | 18.26 | 30.0 |
| No. 6 | 21.91 | 36.0 |
| No. 7 | 25.56 | 42.0 |
| No. 8 | 29.21 | 48.0 |
| No. 10 | 36.51 | 60.0 |

In an embodiment the nozzle has a nozzle exit area to nozzle throat area ratio (A/A*) of 2.1±5%.

In an embodiment the nozzle comprises a nozzle with a nozzle size as set out in the leftmost column of the following table and the thrust reducer has a thrust reducer outlet diameter as set out in the following table for the nozzle size and thrust reduction portion length at least as long as set out in the following table for the nozzle size:

| Nozzle | Outlet | Thrust reduction |
|---|---|---|
| Size | Diameter (mm) | portion length (mm) |
| No. 3 | 13.32 | 78.5 |
| No. 4 | 17.76 | 104.5 |
| No. 5 | 22.20 | 130.5 |
| No. 6 | 26.64 | 157.0 |
| No. 7 | 31.08 | 183.0 |
| No. 8 | 35.52 | 209.0 |
| No. 10 | 44.40 | 261.0 |

In an embodiment the predetermined pressure range is 80 psi or greater and the nozzle has an A/A* area ratio of 1.63±5% wherein the nozzle comprises a nozzle with a nozzle size as set out in the leftmost column of the following table and the thrust reducer has a thrust reducer outlet diameter as set out in the following table for the nozzle size and thrust reduction portion length ranging between the preferred length and the minimum length for effective thrust reduction as set out in the following table for the nozzle size:

| | Preferred | Preferred | Minimum Length for |
|---|---|---|---|
| Nozzle | Diameter | Length | effective thrust |
| Size | (mm) | (mm) | reduction (mm) |
| No. 3 | 11.8 | 37.5 | 23.5 |
| No. 4 | 15.7 | 50.0 | 31.0 |
| No. 5 | 19.6 | 62.5 | 39.0 |
| No. 6 | 23.5 | 75.0 | 46.5 |
| No. 7 | 27.4 | 87.5 | 54.5 |
| No. 8 | 31.3 | 100.0 | 62.0 |
| No. 10 | 39.2 | 125.0 | 77.5 |

In an embodiment the predetermined pressure range is 80 psi to 120 psi and the nozzle has an A/A* area ratio of 1.63±5% wherein the nozzle comprises a #3 nozzle and wherein the length of the thrust reducer is between 7.5 mm and 67.5 mm and the diameter of the thrust reducer is between 10.00 mm and 13.5 mm.

In an embodiment the predetermined pressure range is 80 psi to 120 psi and the nozzle has an A/A* area ratio of 1.63±5% wherein the nozzle comprises a #4 nozzle and wherein the length of the thrust reducer is between 10.0 mm and 90 mm and the diameter of the thrust reducer is between 13 mm and 18 mm.

In an embodiment the predetermined pressure range is 80 psi to 120 psi and the nozzle has an A/A* area ratio of 1.63±5% wherein the nozzle comprises a #5 nozzle and wherein the length of the thrust reducer is between 12.5 mm and 112.5 mm and the diameter of the thrust reducer is between 12.5 mm and 22.5 mm.

In an embodiment the predetermined pressure range is 80 psi to 120 psi and the nozzle has an A/A* area ratio of 1.63±5% wherein the nozzle comprises a #6 nozzle and wherein the length of the thrust reducer is between 15 mm and 135.0 mm and the diameter of the thrust reducer is between and 27.1 mm.

In an embodiment the predetermined pressure range is 80 psi to 120 psi and the nozzle has an A/A* area ratio of 1.63±5% wherein the nozzle comprises a #7 nozzle and wherein the length of the thrust reducer is between 17.5 mm and 157.5 mm and the diameter of the thrust reducer is between 23 mm and 31.5 mm.

In an embodiment the predetermined pressure range is 80 psi to 120 psi and the nozzle has an A/A* area ratio of 1.63±5% wherein the nozzle comprises a #8 nozzle and wherein the length of the thrust reducer is between 20.0 mm and 179.5 mm and the diameter of the thrust reducer is between 26.5 mm and 36.0 mm.

In an embodiment the predetermined pressure range is 80 psi to 120 psi and the nozzle has an A/A* area ratio of 1.63±5% wherein the nozzle comprises a #10 nozzle and wherein the length of the thrust reducer is between 25 mm and 224.5 mm and the diameter of the thrust reducer is between 33.0 mm and 45.0 mm.

In an embodiment the coupling portion comprises a female thread.

In an embodiment the thrust reducer body includes an inlet body portion that is removably received within the thrust reducer conduit of the thrust reducer body.

In an embodiment the inlet body portion comprises a removable sleeve that is removably received within the body.

In another aspect there is provided a thrust reducer arranged to connect to and reduce s operational thrust of a blast nozzle, the blast nozzle comprising a body with a conduit therethrough extending from a nozzle inlet for connection to a source of blasting gas and a nozzle outlet for emitting a jet, the nozzle conduit including a throat between the nozzle inlet and the nozzle outlet, the nozzle outlet having a nozzle outlet area and the throat having a throat area, a ratio of the nozzle outlet area to the throat area constraining the nozzle to produce a supersonic jet,
the thrust reducer comprising a body with a thrust reducer conduit therethrough, the body being of sufficient length and diameter to cause a flow condition of the jet received from the nozzle outlet to be modified such that a zone of sub-atmospheric pressure forms adjacent a face of the outlet of the nozzle whereby a pressure differential arises between the zone of sub-atmospheric pressure and surrounding atmosphere thereby creating an anti-thrust force in opposition to thrust of the nozzle.

In an embodiment the thrust reducer body includes a coupling portion arranged to connect to a portion of the nozzle adjacent the nozzle outlet and a thrust reduction portion defining the thrust reducer conduit, wherein the thrust reduction portion extends from the coupling portion to a thrust reducer outlet of the thrust reducer.

In an embodiment the predetermined pressure range is 80 psi or greater.

In an embodiment the nozzle has a nozzle exit area to nozzle throat area ratio (A/A*) of 1.63±5%.

In an embodiment the nozzle comprises a #3 nozzle and the thrust reducer has a thrust reducer outlet diameter of 11.75±2.5% mm and a thrust reduction portion length of 37.50±5% mm.

In an embodiment the nozzle comprises a #4 nozzle and the thrust reducer has a thrust reducer outlet diameter of 15.67±2.5% mm and a thrust reduction portion length of 50.00±5% mm.

In an embodiment the nozzle comprises a #5 nozzle and the thrust reducer has a thrust reducer outlet diameter of 19.58±2.5% mm and a thrust reduction portion length of 62.50±5% mm.

In an embodiment the nozzle comprises a #6 nozzle and the thrust reducer has a thrust reducer outlet diameter of 23.50±2.5% mm and a thrust reduction portion length of 75.00±5% mm.

In an embodiment the nozzle comprises a #7 nozzle and the thrust reducer has a thrust reducer outlet diameter of 27.1±2.5% mm and a thrust reduction portion length of 87.50±5% mm.

In an embodiment the nozzle comprises a #8 and the thrust reducer has a thrust reducer outlet diameter of 31.33±2.5% mm and a thrust reduction portion length of 100±5% mm.

In an embodiment the nozzle comprises a #10 nozzle and the thrust reducer has a thrust reducer outlet diameter of 39.16±2.5% mm and a thrust reduction portion length of 125±5% mm.

In an embodiment the nozzle comprises a nozzle with nozzle size as set out in the leftmost column of the following table and the thrust reducer has a thrust reducer outlet diameter as set out in the following table for the nozzle size and thrust reduction portion length at least as long as set out in the following table for the nozzle size:

| Nozzle | Thrust reduction | Outlet |
|---|---|---|
| Size | portion length (mm) | Diameter (mm) |
| No. 3 | 67.5 | 13.5 |
| No. 4 | 90.0 | 18.0 |
| No. 5 | 112.5 | 22.5 |
| No. 6 | 135.0 | 27.1 |
| No. 7 | 157.5 | 31.5 |
| No. 8 | 179.5 | 36.0 |
| No. 10 | 224.5 | 45.0 |

In an embodiment the nozzle comprises a nozzle with nozzle size as set out in the leftmost column of the following table and the thrust reducer has a thrust reducer outlet diameter as set out in the following table for the nozzle size and thrust reduction portion length at least as long as set out in the following table for the nozzle size:

| Nozzle | Thrust reduction | Outlet |
|---|---|---|
| Size | portion length (mm) | Diameter (mm) |
| No. 3 | 17.5 | 10.0 |
| No. 4 | 23.0 | 13.0 |
| No. 5 | 29.0 | 16.5 |
| No. 6 | 34.5 | 20.0 |
| No. 7 | 40.5 | 23.0 |
| No. 8 | 46.0 | 26.5 |
| No. 10 | 57.5 | 33.0 |

In an embodiment the nozzle has a nozzle exit area to nozzle throat area ratio (A/A*) of 1.42±5%.

In an embodiment the nozzle comprises a nozzle with a nozzle size as set out in the leftmost column of the following table and the thrust reducer has a thrust reducer outlet diameter as set out in the following table for the nozzle size and thrust reduction portion length at least as long as set out in the following table for the nozzle size:

| Nozzle | Outlet | Thrust reduction |
|---|---|---|
| Size | Diameter (mm) | portion length (mm) |
| No. 3 | 10.95 | 18.0 |
| No. 4 | 14.60 | 24.0 |
| No. 5 | 18.26 | 30.0 |
| No. 6 | 21.91 | 36.0 |
| No. 7 | 25.56 | 42.0 |
| No. 8 | 29.21 | 48.0 |
| No. 10 | 36.51 | 60.0 |

In an embodiment the nozzle has a nozzle exit area to nozzle throat area ratio (A/A*) of 2.1±5%.

In an embodiment the nozzle comprises a nozzle with a nozzle size as set out in the leftmost column of the following table and the thrust reducer has a thrust reducer outlet diameter as set out in the following table for the nozzle size and thrust reduction portion length at least as long as set out in the following table for the nozzle size:

| Nozzle | Outlet | Thrust reduction |
|---|---|---|
| Size | Diameter (mm) | portion length (mm) |
| No. 3 | 13.32 | 78.5 |
| No. 4 | 17.76 | 104.5 |
| No. 5 | 22.20 | 130.5 |
| No. 6 | 26.64 | 157.0 |
| No. 7 | 31.08 | 183.0 |
| No. 8 | 35.52 | 209.0 |
| No. 10 | 44.40 | 261.0 |

In an embodiment the predetermined pressure range is 80 psi or greater and the nozzle has an A/A* area ratio of 1.63±5% wherein the nozzle comprises a nozzle with a nozzle size as set out in the leftmost column of the following table and the thrust reducer has a thrust reducer outlet diameter 10 as set out in the following table for the nozzle size and thrust reduction portion length ranging between the preferred length and the minimum length for effective thrust reduction as set out in the following table for the nozzle size:

| | Preferred | Preferred | Minimum Length for |
|---|---|---|---|
| Nozzle | Diameter | Length | effective thrust |
| Size | (mm) | mm | reduction (mm) |
| No. 3 | 11.8 | 37.5 | 23.5 |
| No. 4 | 15.7 | 50.0 | 31.0 |
| No. 5 | 19.6 | 62.5 | 39.0 |
| No. 6 | 23.5 | 75.0 | 46.5 |
| No. 7 | 27.4 | 87.5 | 54.5 |
| No. 8 | 31.3 | 100.0 | 62.0 |
| No. 10 | 39.2 | 125.0 | 77.5 |

In an embodiment the predetermined pressure range is 80 psi to 120 psi and the nozzle has an A/A* area ratio of 1.63±5% wherein the nozzle comprises a #3 nozzle and wherein the length of the thrust reducer is between 7.5 mm and 67.5 mm and the diameter of the thrust reducer is between 10.00 mm and 13.5 mm.

In an embodiment the predetermined pressure range is 80 psi to 120 psi and the nozzle has an A/A* area ratio of 1.63±5% wherein the nozzle comprises a #4 nozzle and wherein the length of the thrust reducer is between 10.0 mm and 90 mm and the diameter of the thrust reducer is between 13 mm and 18 mm.

In an embodiment the predetermined pressure range is 80 psi to 120 psi and the nozzle has an A/A* area ratio of 1.63±5% wherein the nozzle comprises a #5 nozzle and wherein the length of the thrust reducer is between 12.5 mm and 112.5 mm and the diameter of the thrust reducer is between 12.5 mm and 22.5 mm.

In an embodiment wherein the predetermined pressure range is 80 psi to 120 psi and the nozzle has an A/A* area ratio of 1.63±5% wherein the nozzle comprises a #6 nozzle and wherein the length of the thrust reducer is between 15 mm and 135.0 mm and the diameter of the thrust reducer is between 20 mm and 27.1 mm.

In an embodiment the predetermined pressure range is 80 psi to 120 psi and the nozzle has an A/A* area ratio of 1.63±5% wherein the nozzle comprises a #7 nozzle and wherein the length of the thrust reducer is between 17.5 mm and 157.5 mm and the diameter of the thrust reducer is between 23 mm and 31.5 mm.

In an embodiment the predetermined pressure range is 80 psi to 120 psi and the nozzle has an A/A* area ratio of 1.63±5% wherein the nozzle comprises a #8 nozzle and wherein the length of the thrust reducer is between 20.0 mm and 179.5 mm and the diameter of the thrust reducer is between 26.5 mm and 36.0 mm.

In an embodiment the predetermined pressure range is 80 psi to 120 psi and the nozzle has an A/A* area ratio of 1.63±5% wherein the nozzle comprises a #10 nozzle and wherein the length of the thrust reducer is between 25 mm and 224.5 mm and the diameter of the thrust reducer is between 33.0 mm and 45.0 mm.

In an embodiment the coupling portion comprises a female thread.

In an embodiment the thrust reducer body includes an inlet body portion that is removably received within the thrust reducer conduit of the thrust reducer body.

In an embodiment the inlet body portion comprises a removable sleeve that is removably received within the body.

In an embodiment the nozzle has a nozzle exit area to nozzle throat area ratio (A/A*) of between 1.42 and 2.1 and wherein the nozzle comprises a #3 nozzle and the silencer has a silencer outlet diameter of between 10 mm and 13.6 mm and a minimum sound suppression portion length of between 7.5 mm and 78.5 mm.

In an embodiment the nozzle has a nozzle exit area to nozzle throat area ratio (A/A*) of between 1.42 and 2.1 and wherein the nozzle comprises a #4 nozzle and the silencer has a silencer outlet diameter of between 12.4 mm and 18.1 mm and a minimum sound suppression portion length of between 10 mm and 104 mm.

In an embodiment the nozzle has a nozzle exit area to nozzle throat area ratio (A/A*) of between 1.42 and 2.1 and wherein the nozzle comprises a #5 nozzle and the silencer has a silencer outlet diameter of between 15.5 mm and 22.6 mm and a minimum sound suppression portion length of between 12.5 mm and 130.5 mm.

In an embodiment the nozzle has a nozzle exit area to nozzle throat area ratio (A/A*) of between 1.42 and 2.1 and wherein the nozzle comprises a #6 nozzle and the silencer has a silencer outlet diameter of between 18.5 mm and 27.1 mm and a minimum sound suppression portion length of between 15 mm and 157 mm.

In an embodiment the nozzle has a nozzle exit area to nozzle throat area ratio (A/A*) of between 1.42 and 2.1 and wherein the nozzle comprises a #7 nozzle and the silencer has a silencer outlet diameter of between 21.7 mm and 31.6 mm and a minimum sound suppression portion length of between 17.5 mm and 183 mm.

In an embodiment the nozzle has a nozzle exit area to nozzle throat area ratio (A/A*) of between 1.42 and 2.1 and wherein the nozzle comprises a #8 nozzle and the silencer has a silencer outlet diameter of between 24.8 mm and 36.1 mm and a minimum sound suppression portion length of between 20 mm and 209 mm.

In an embodiment the nozzle has a nozzle exit area to nozzle throat area ratio (A/A*) of between 1.42 and 2.1 and wherein the nozzle comprises a #10 nozzle and the silencer has a silencer outlet diameter of between 31.0 mm and 45.2 mm and a minimum sound suppression portion length of between 25 mm and 261 mm.

Further features and embodiments will be described in the detailed description that follows. For example, thrust reduction apparatus according to the various dimensions and to suit the various nozzle sizes that will be described comprise embodiments of aspects of the present disclosure.

### BRIEF DESCRIPTION OF THE DRAWINGS

Embodiments in accordance with the present disclosure will be described, by way of example, in the following Detailed Description of Embodiments which provides sufficient information for those skilled in the art to perform the subject matter that is disclosed herein. The Detailed Description of Embodiments is not to be regarded as limiting the scope of the preceding Summary section in any way. The Detailed Description will make reference to the accompanying drawings, by way of example, in which:

FIG. 1 depicts a prior art blast nozzle in use.

FIG. 2 is a view of blast nozzle for use with a nozzle thrust reduction apparatus according to an embodiment.

FIG. 3 is a view of a nozzle outlet end of the blast nozzle of FIG. 2.

FIG. 4 is a side view of the nozzle of FIG. 2.

FIG. 5 is a longitudinal cross section of the nozzle of FIG. 3 along the line B-B of FIG. 4.

FIGS. 6 and 7 are tables presenting dimensions and ratios of a number of ideally expanded nozzles including the nozzle of FIGS. 2 to 5.

FIG. 8 is a diagram of the geometry of a nozzle, such as a nozzle according to FIGS. 3 to 8, producing an ideally expanded jet.

FIG. 9 is a diagram of a nozzle with a different geometry producing an overexpanded jet.

FIG. 10 is a diagram of a nozzle with another different geometry producing an underexpanded jet.

FIG. 11 is a diagram of a thrust reduction system according to an embodiment.

FIG. 12 is a view of an outlet end of a thrust reduction apparatus or “thrust reducer” according to an embodiment.

FIG. 13 is a view of a coupling end of the thrust reducer.

FIG. 14 is an axial cross section of the thrust reducer.

FIG. 15 is an axial cross section through a blast nozzle that is configured for producing an ideally expanded jet at or near the ideal supply pressure.

FIG. 16 is a detail of the thrust reduction system shown in use.

FIG. 17 is a diagram depicting streamlines and velocity vectors of a jet issuing from a blast nozzle into a thrust reducer.

FIG. 18 is a detail of the diagram of FIG. 17.

FIG. 19 is a table showing an approximation of thrust reduction when P_end is 10 kPa for each of four different nozzle sizes.

FIG. 20 is a table showing approximated thrust reduction values for four different sized nozzles for a range of pressures from 0 to 101 kPa.

FIG. 21 is a graph of approximated thrust reduction forces for various P_end pressure by nozzle size shown in the table of FIG. 20 above.

FIG. 22 is a table illustrating that thrust reduction increases as the surface area exposed to P_end is increased.

FIG. 23 is a table demonstrating thrust reduction for a convergent-divergent nozzle operating at an inlet pressure of 100 psi and connected to a thrust reduction apparatus.

FIG. 24 is a graph illustrating a situation in which the jet no longer expands sufficiently to strongly interact with the internal wall of the conduit.

FIG. 25 is a detail of the graph of FIG. 24.

FIG. 26 depicts a thrust reducer that includes a ramp and step at an axial location downstream of the nozzle exit.

The dimensions in the Figures are in mm and are exemplary only and non-limiting.

### DETAILED DESCRIPTION OF EMBODIMENTS

Whilst the following discussion pertains to jets composed of gas, the inventors have observed nozzle flows for both gas only (for example, air), and particle laden flows (air containing abrasive particles) and noted similar flow structures with the aid of high speed optical imaging.

The described effects have been experimentally measured for gas only and particle laden flows.

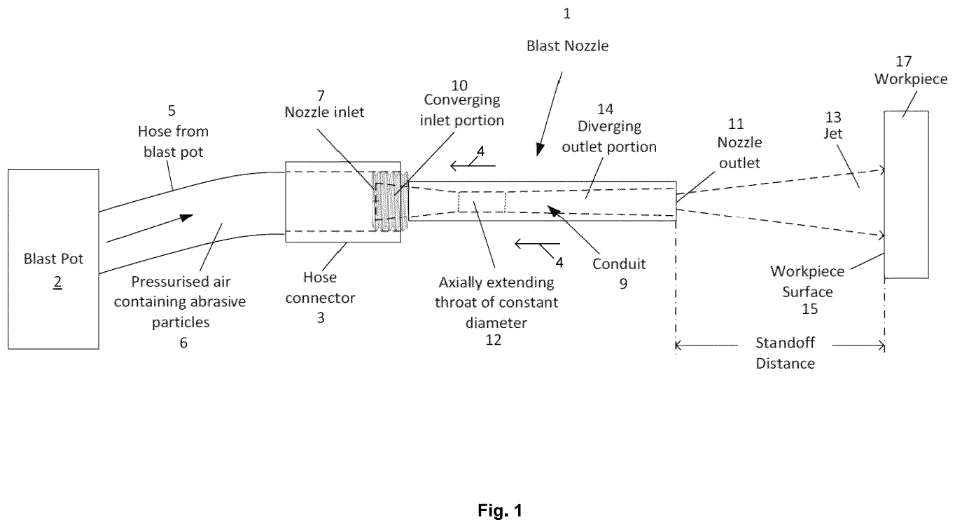

Blast nozzles such as the blast nozzle of FIG. 1, which has previously been discussed, are generally designed to accelerate particles in the gas 6 through the diverging outlet portion 14 to reach a maximum velocity at the nozzle outlet 11. In contrast, recently the present Applicant has developed a nozzle that operates in a substantially ideally expanded mode so that the gas exiting the nozzle is at substantially ambient pressure. That nozzle is the subject of International patent application No. PCT/AU2021/050827, the content of which is hereby incorporated by reference. Such nozzles may have an outlet to throat area ratio of about 1.63 in order to deliver an ideal expansion ratio at the selected design pressure (P_design), for example 100 psi, with consideration for viscous flow. In contrast to the nozzle of FIG. 1, they preferably have a throat of zero width, i.e. no axial extension. The ideally expanded nozzle has been found to have significantly improved abrading performance characteristics over those of the prior art nozzles, such as that of FIG. 1, because they are able to effectively prolong the integrity of the jet leaving the nozzle outlet to thereby increase the energy of the particles entrained in the jet as those particles travel between the outlet and the workpiece.

Blast nozzles are generally very noisy during operation, and it is known to provide silencers for blast nozzles, such as the nozzle 1 of FIG. 1. The present Applicant has devoted time to develop a silencer for use with the ideally expanded blast nozzle that is the subject international patent application No. PCT/AU2021/050827, the content of which is hereby incorporated herein by reference. The research scope leading to the patent application was focused on identifying the mechanism and characteristics of blast nozzle noise generation and the process and mechanism for reducing the effect of this noise generation on the surrounding environment.

A new and surprising feature of the silencers produced during this process became apparent as the prototype silencers were tested. Operators reported a significant reduction in blast nozzle thrust when testing the nozzle with the silencer connected compared to when testing the nozzle without the silencer. Whilst not in the original scope of the silencer development project, it became clear that the unexpected benefits associated with the observed reduction in blast nozzle thrust were significant.

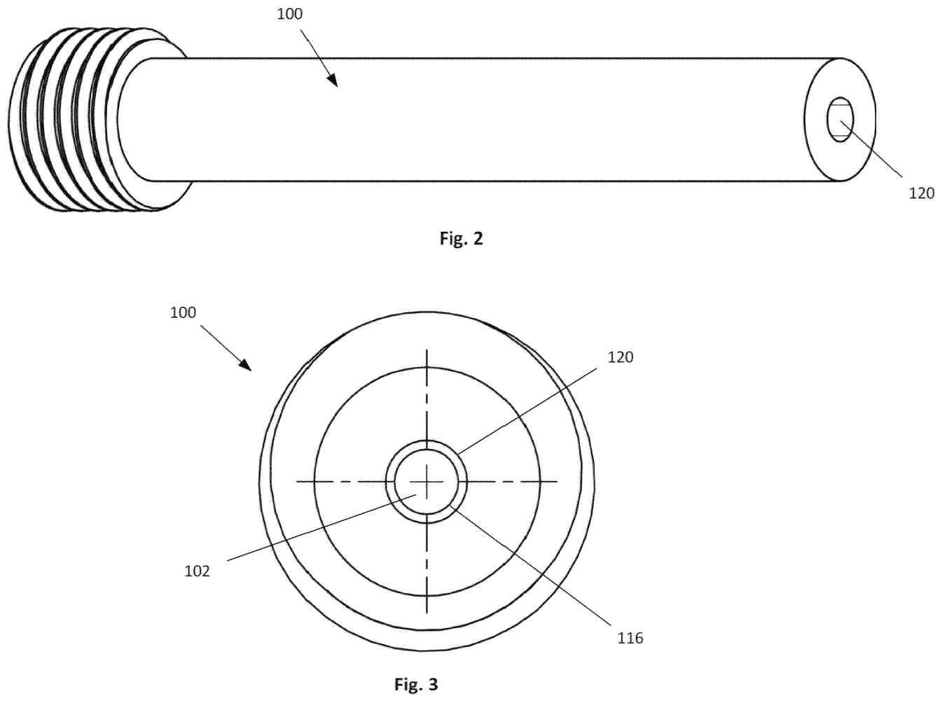

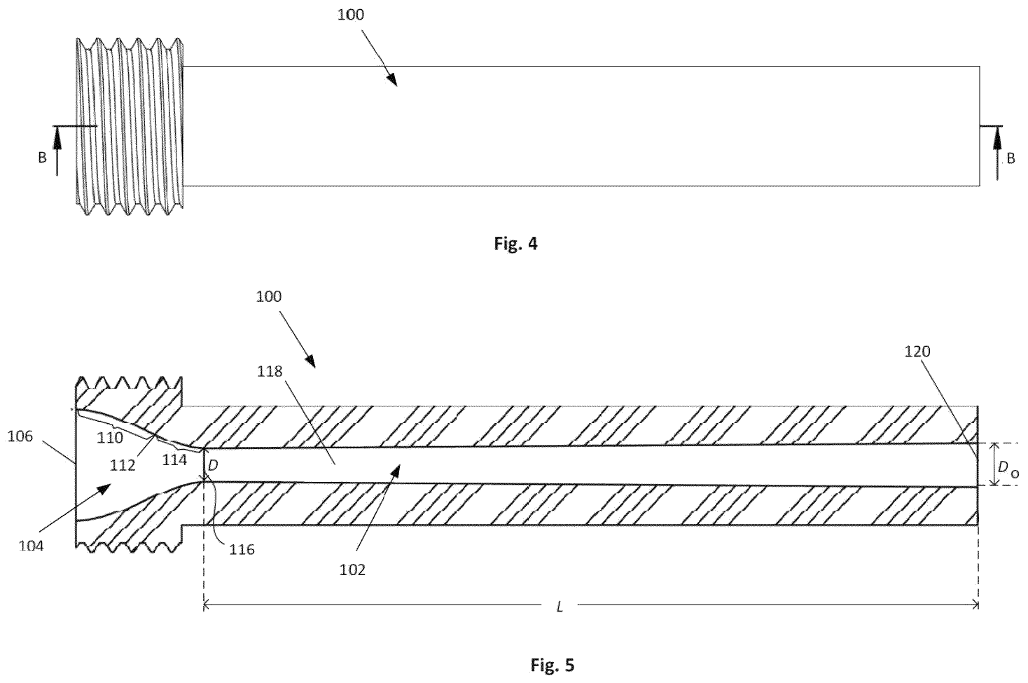

Blast nozzles are typically sized by their throat diameter in fractions of an inch, e.g. a #6 blast nozzle has a throat diameter of 6/16″ whereas a #3 blast nozzle has a throat diameter of 3/16″. FIGS. 2 to 5 illustrate a 220 mm #6 nozzle 100 that is designed for ideal expansion as discussed in the aforementioned international patent application No. PCT/AU2021/050827. FIG. 5 depicts a longitudinal cross section through the nozzle showing the conduit therethrough with the dimension L being a distance from throat 116 to nozzle outlet 120 of 220 mm.

The blast nozzle 100 is formed with a conduit 102 therethough for accelerating air with abrasive particles at a predetermined pressure. In the present case nozzle 100 is designed for an inlet air pressure of 80 to greater than 120 psi and nominally 100 psi to discharge to sea level ambient atmospheric pressure at 27 degrees C. The pressurised air contains abrasive particles such as #80 Garnet to abrade a workpiece. The conduit 102 includes an inlet portion 104 that converges from an inlet opening 106, for receiving the compressed air, to a throat 116 for accelerating the air to a sonic speed. The inlet portion 104 may generally follow a concave-convex curve, as illustrated, with an initial concave portion 110 that proceeds through an inflection point 112 to a convex portion 114. The convex portion 114 ends in a throat 116, of zero axial length along the conduit, from which an outlet portion 118 extends. The outlet portion 118 diverges from the throat 116 to a nozzle outlet 120, of diameter Dₒ, for accelerating the air from the throat 116 to a super-sonic speed. It should be realised that while it is preferable to make use of an inlet portion shaped with a concave-convex curve it is not essential to do so and blast nozzles with other shaped inlets, for example frusto-conical inlets are also workable.

It is known that an ideally expanded supersonic jet can be produced by a converging/ expanding blast nozzle when operated at the design inlet pressure for the specific nozzle exit to nozzle throat area ratio (A/A*) such as the nozzle discussed in the international patent application No. PCT/AU2021/050827. Other blast nozzle geometries will produce an ideally expanded jet when operated at the ideal supply pressure for the particular nozzle exit to nozzle throat area ratio A/A*. Table 2 lists the exit Mach number, ideal pressure ratio and ideal supply pressure (P design) pressure for a range of nozzle A/A* ratios. The ideal supply pressure is the pressure at which a nozzle with a A/A* area ratio creates an ideally expanded jet.

TABLE 2
Exit Mach number, ideal pressure ratio and ideal supply pressure for
a range of nozzle A/A* ratios

| Area Ratio | Exit | Ideal Pressure | Ideal Supply | Ideal Supply |
|---|---|---|---|---|
| (Nozzle_Exit/ | Mach | Ratio (P_total/ | Pressure (kPa) | Pressure (psi) |
| Throat A/A*) | Number | P_ambient) | P_Design | P_Design |
| 1.00 | 1 | 1.89 | 189.29 | 27.45 |
| 1.00 | 1.05 | 2.01 | 200.85 | 29.13 |
| 1.01 | 1.1 | 2.14 | 213.51 | 30.97 |
| 1.02 | 1.15 | 2.27 | 227.36 | 32.98 |
| 1.03 | 1.2 | 2.42 | 242.50 | 35.17 |
| 1.05 | 1.25 | 2.59 | 259.03 | 37.57 |
| 1.07 | 1.3 | 2.77 | 277.07 | 40.19 |
| 1.09 | 1.35 | 2.97 | 296.76 | 43.04 |
| 1.11 | 1.4 | 3.18 | 318.23 | 46.16 |
| 1.14 | 1.45 | 3.42 | 341.62 | 49.55 |
| 1.18 | 1.5 | 3.67 | 367.10 | 53.24 |
| 1.21 | 1.55 | 3.95 | 394.85 | 57.27 |
| 1.25 | 1.6 | 4.25 | 425.04 | 61.65 |
| 1.29 | 1.65 | 4.58 | 457.89 | 66.41 |
| 1.34 | 1.7 | 4.94 | 493.60 | 71.59 |
| 1.39 | 1.75 | 5.32 | 532.41 | 77.22 |
| 1.44 | 1.8 | 5.75 | 574.58 | 83.34 |
| 1.50 | 1.85 | 6.20 | 620.37 | 89.98 |
| 1.56 | 1.9 | 6.70 | 670.06 | 97.18 |
| 1.62 | 1.95 | 7.24 | 723.98 | 105.00 |
| 1.69 | 2 | 7.82 | 782.44 | 113.48 |
| 1.76 | 2.05 | 8.46 | 845.81 | 122.68 |
| 1.84 | 2.1 | 9.14 | 914.47 | 132.63 |
| 1.92 | 2.15 | 9.89 | 988.81 | 143.41 |
| 2.00 | 2.2 | 10.69 | 1069.27 | 155.08 |
| 2.10 | 2.25 | 11.56 | 1156.31 | 167.71 |
| 2.19 | 2.3 | 12.50 | 1250.43 | 181.36 |
| 2.30 | 2.35 | 13.52 | 1352.14 | 196.11 |
| 2.40 | 2.4 | 14.62 | 1462.00 | 212.05 |
| 2.52 | 2.45 | 15.81 | 1580.61 | 229.25 |
| 2.64 | 2.5 | 17.09 | 1708.59 | 247.81 |
| 2.76 | 2.55 | 18.47 | 1846.62 | 267.83 |
| 2.90 | 2.6 | 19.95 | 1995.40 | 289.41 |
| 3.04 | 2.65 | 21.56 | 2155.69 | 312.66 |
| 3.18 | 2.7 | 23.28 | 2328.29 | 337.69 |
| 3.34 | 2.75 | 25.14 | 2514.03 | 364.63 |
| 3.50 | 2.8 | 27.14 | 2713.83 | 393.61 |
| 3.67 | 2.85 | 29.29 | 2928.62 | 424.76 |
| 3.85 | 2.9 | 31.59 | 3159.41 | 458.23 |
| 4.04 | 2.95 | 34.07 | 3407.25 | 494.18 |
| 4.23 | 3 | 36.73 | 3673.27 | 532.76 |

It is also known that nozzles as described, when operated at the ideal supply pressure,
produce a supersonic jet that is substantially at ambient pressure when it exits the blast nozzle i.e., an ideally expanded jet,
exhibit a train of recurring shock diamonds in the jet downstream of the nozzle exit,
produce a jet stream that is less turbulent than if operated at an inlet pressure that is greater than or less than ideal supply pressure. ie at an inlet pressure that causes the jet exiting the blast nozzle to be overexpanded or under expanded.

It is also known that when nozzle inlet pressure increases above the ideal supply pressure for the a given nozzle A/A* ratio, the supersonic jet that is produced will progressively become more underexpanded and when the nozzle inlet pressure decreases below the ideal supply pressure for the a given nozzle A/A* ratio, the supersonic jet that is produced will progressively become more overexpanded. Overexpanded and underexpanded supersonic jets are more turbulent than ideally expanded jets and the jet structure breaks down at a shorter distance after the nozzle exit compared to an ideally expanded jet.

A ratio of the area A of the nozzle outlet 120 to area A* of the throat 116 a (A/A*) is selected for expansion of the air through the nozzle 100 so it is neither under-expanded nor overexpanded as it exits the outlet 120 but rather is “ideally” expanded. The area ratio is about 1.63 for compressed air applied in the range of 80 psi to 120 psi above ambient pressure and optimally 100 psi. Accordingly, the pressurised air exits the nozzle outlet 120 in a jet at ambient pressure. The jet imparts drag on the abrasive particles between the nozzle outlet and the workpiece. Consequently, the energy of the particles is increased over the standoff distance between the nozzle outlet 120 and the surface of the workpiece. The standoff distance is typically around 350 mm to 600 mm from the nozzle outlet to the workpiece in use. Consequently, nozzles according to embodiments herein are more effectively able to clean/abrade the surface of the workpiece than a nozzle designed to work in an overexpanded or underexpanded mode.

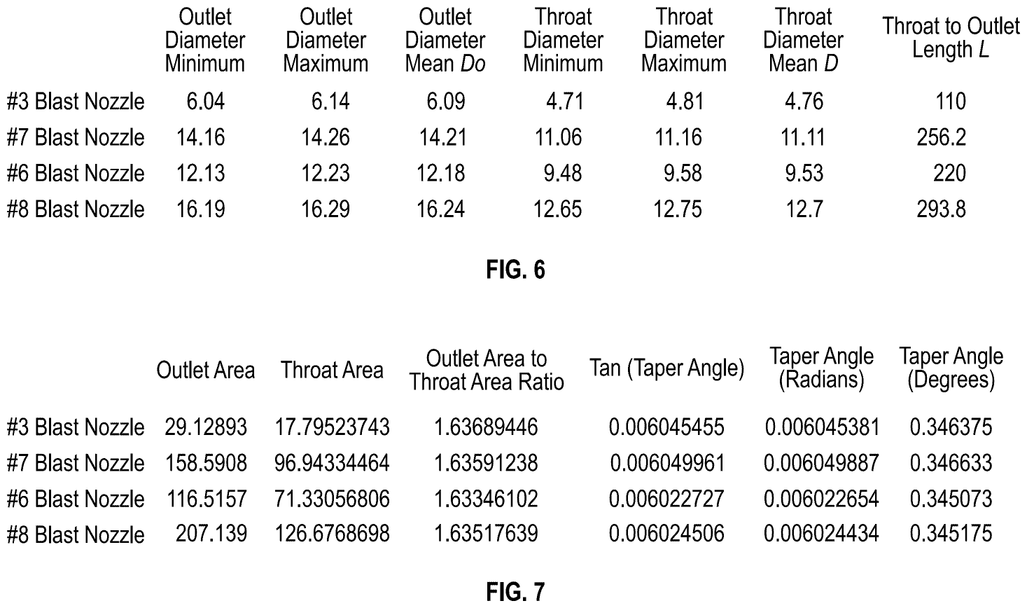

The dimensions for a #6 blast nozzle as illustrated are set out in the third rows of the tables of FIGS. 6 and 7. Namely, the inlet opening 106 has a diameter of 32 mm, the throat 116 has a diameter of 9.53 mm and zero length, and the nozzle outlet 120 has a diameter of 12.18 mm. The throat and the nozzle outlet are separated by a distance L of 220 mm. The throat and the nozzle inlet are separated by a distance of about 36 mm. It will be realised that these dimensions are provided for exemplary purposes. Dimensions for #3, #7 and #8 blast nozzles are similarly also set out in the tables of FIGS. 6 and 7.

In determining the optimal nozzle length, it was found that for a #6 nozzle 220 mm was the best length from testing with #60/30 garnet (0.3 mm particle size, 4100 1 g/m³ density). The optimal length for a #6 nozzle may be longer in other embodiments such as 300 mm. There may be other considerations, such as access and ergonomics, which limit the utility of a longer nozzle. In general, longer nozzles are better suited to larger, heavier abrasive blends, whilst shorter nozzles are better suited for lighter and smaller blends. A preferred range on the diverging section length L for embodiments of the nozzle is 70-300 mm.

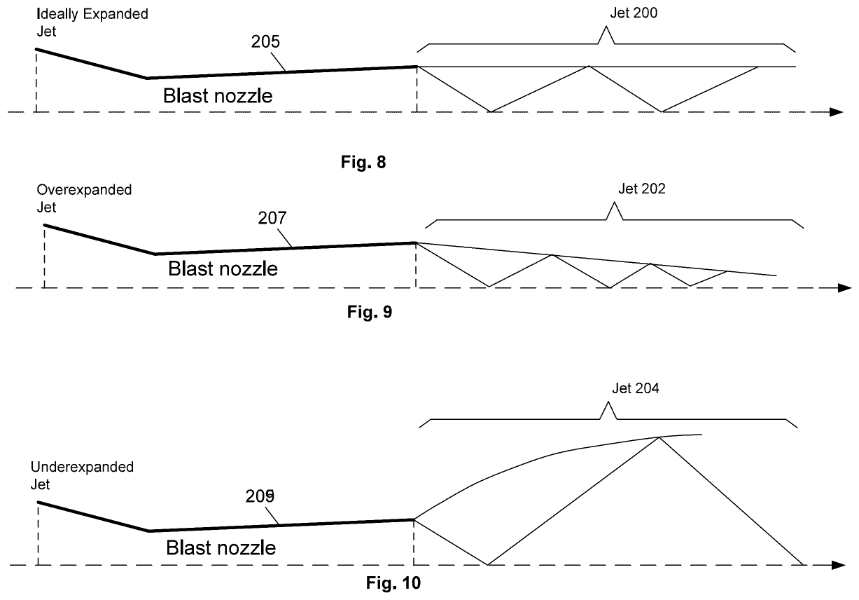

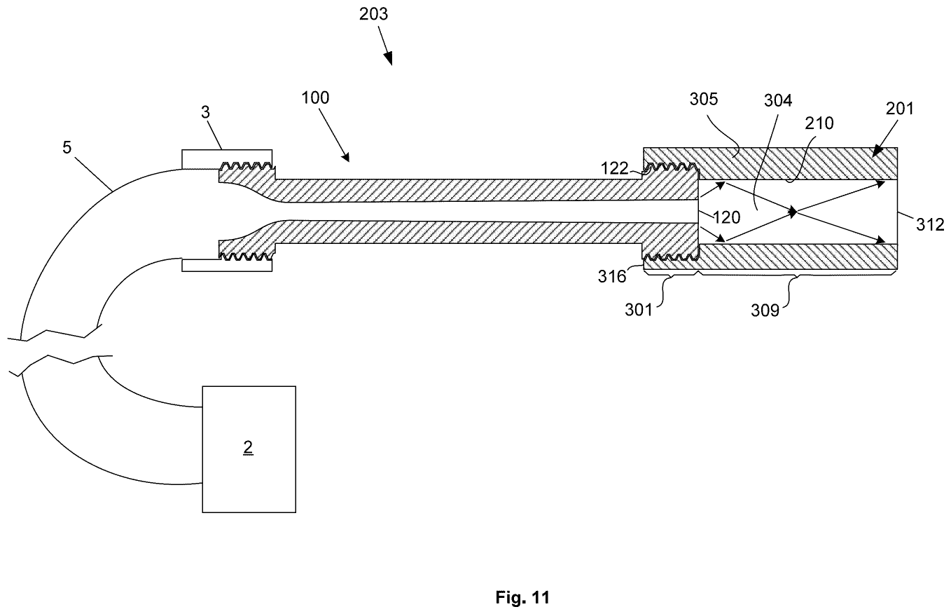

FIGS. 8, 9 and 10 respectively illustrate the profiles of exhaust jets produced by blast nozzles 205, 207 and 209 where the exhaust jets respectively comprise an ideally expanded jet 200 (jet exits nozzle at ambient pressure), an overexpanded jet 202 (jet exits nozzle at less than ambient pressure) and an under-expanded jet 204 (jet exits nozzle at greater than ambient pressure).

It is known that a blast nozzle thrust force in the opposite direction to the flow of a jet, identified by arrows 4 in FIG. 1, increases proportionately with an increase in inlet pressure and with larger size blast nozzles.

The Inventors hypothesised that if the jet exiting the blast nozzle could be modified in such a way to produce an anti-thrust force in in the direction to the flow of the jet, in opposition to the primary force generated by the flow of the jet, reduced nozzle thrust would be generated during the blasting process and then reduced effort would need to be applied by the operator to resist this force.

As will be discussed, the Inventors found that useful nozzle thrust reduction continues to occur for nozzles that are operated at above or below the nozzle design pressure (P_design) i.e., overexpanded or underexpanded jets produced by a nozzle without the thrust reduction device, but the effectiveness of the thrust reduction will be reduced as operation pressure reduces. The limiting minimum pressure for reliable thrust reduction to occur for a nozzle with an area ratio A/A* of 1.42 is 50 psi±5%, with an A/A* of 1.63 is 65 psi±5% and with an A/A* of 2.1 is 100 psi±5%. As inlet pressure increases and the jet becomes more underexpanded, effective thrust reduction continues to occur up to the practical limitation for typical blasting systems—currently 150 psi.

As previously alluded to, the Inventors have discovered that blast nozzle thrust can be reduced. A parameter that has been found to be essential for creating the zone of low sub-atmospheric pressure is the formation of the first half shock diamond that reflects inside the thrust reducer that is created in the modified jet that enters the thrust reducer.

The Inventors have previously found that nozzle silencing occurs when a silencer of sufficient length and diameter to cause the flow condition of the jet received from the exit of the blast nozzle to be modified such that 1 ½ shock cells are created in the jet inside the silencer, no shock cells are created in the jet outside the silencer, and the jet exits the silencer with an established turbulent shear layer, and the jet entrains an annular jet that sits around the outside of the core jet, to thereby enclose and suppress an acoustic emission region of the jet, which is the area from which “screech” and broadband tones are generated.

As will be discussed, the Inventors have found that an apparatus may be provided which provides some thrust reduction alone or an apparatus may be provided which provides both some thrust reduction and some noise suppression characteristics. Both versions are useful.

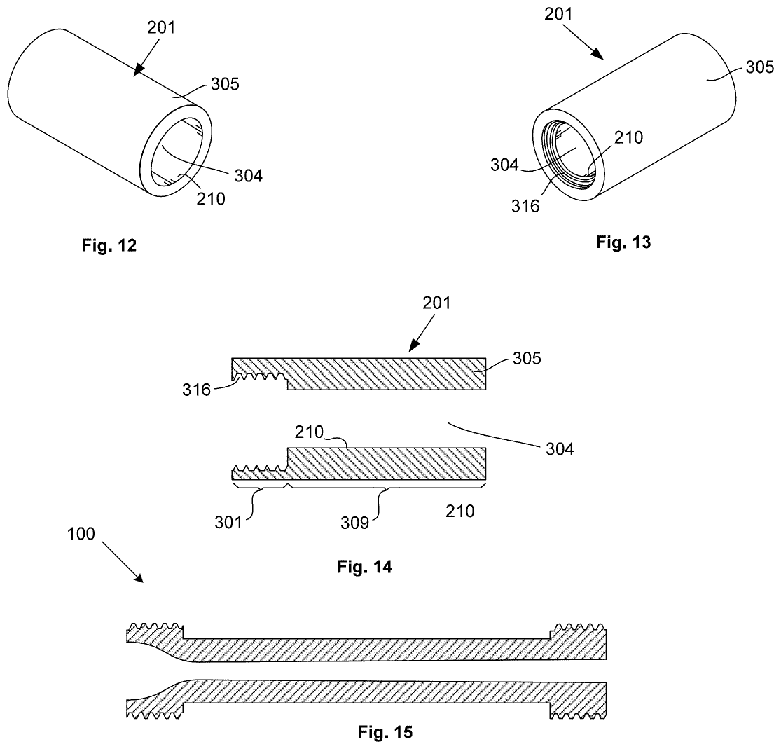

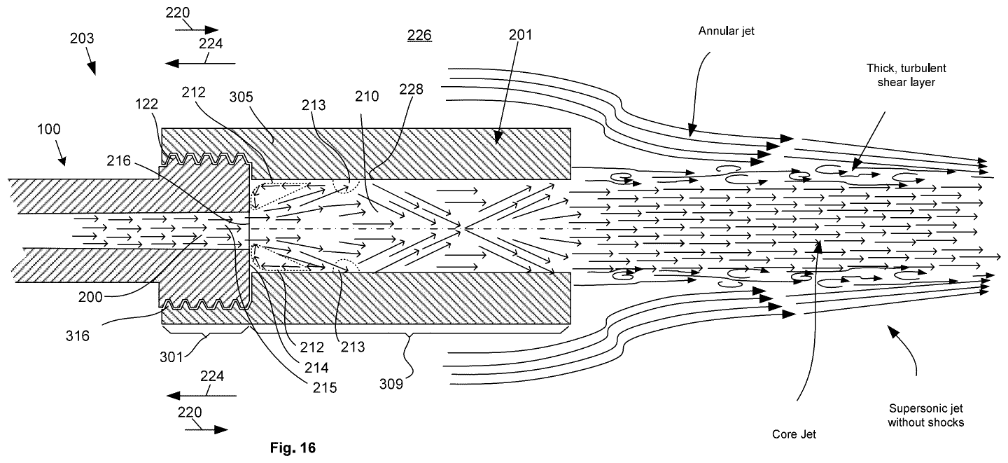

FIG. 11 depicts a thrust reduction apparatus or “thrust reducer” 201 shown in use connected to a blast nozzle 100. FIGS. 12, 13 and 14 are isometric views of an outlet end of the nozzle, inlet end of the nozzle and axial cross section through the nozzle, whilst FIG. 16 is an axial cross section through the blast nozzle 100. FIG. 11 shows the thrust reducer 201 connected to the blast nozzle 100, which in turn is coupled to a source of pressurised gas in the form of a blast pot 2 to thereby provide an overall blasting thrust reduction system 203. The thrust reducer 201 is comprised of a body 305, preferably of a hardwearing material, that has a conduit 304 formed therethrough. A coupling portion 301 of the body 305 is provided which includes a female coupling thread 316 formed concentric with the thrust reduction device conduit 304 for mating with a complementary male thread 122 formed about an outlet end of the blast nozzle 100, adjacent nozzle outlet 120. It will be realised that other suitable fastening arrangements are possible, such as a bayonet type fastening arrangement. Furthermore, in some embodiments the nozzle and the thrust reduction device may be integrally formed together in a single piece.

Accordingly, as illustrated in FIG. 11, the body 305 of the thrust reduction apparatus 201 includes a coupling portion 301 arranged to connect to a complementary coupling portion of the nozzle such as male thread 122 of the nozzle 100 adjacent the nozzle outlet 120. The body 305 also includes a thrust reduction portion 309 extending from the coupling portion 301 to thrust reducer outlet 312.

FIG. 16 is a stylized diagram of the thrust reduction system 203 in use showing flow of gas, as indicated by arrows, through the blast nozzle 100 and thrust reducer 201. It will be observed from

FIG. 16 and FIGS. 17 and 18 that the conduit 210 creates a zone of sub-atmospheric pressure 212 directly adjacent to the face 214 of the nozzle exit 216, resulting in a pressure differential 218 between the pressure of the ambient atmosphere 226 and the pressure in the zone of sub-atmospheric pressure 220.

The pressure differential 218 creates a force 220 in the opposite direction to the blast nozzle thrust 224. The force 220 in the opposite direction to the blast nozzle thrust 224 is due to the pressure differential 218. Namely, the pressure of the external atmosphere 226, which is greater than the pressure in the zone of sub-atmospheric pressure, applied to external surfaces of the nozzle, thrust 10 reducer and hose, urges the face 214 of the nozzle 100 toward the zone of sub-atmospheric pressure 212 thereby resulting in an anti-thrust force 220, which acts in opposite direction to the thrust force 214 thereby resulting in a reduced net thrust being applied to an operator of the nozzle.

As the jet 200 exits the nozzle 205 the combined effects of jet expansion, entrainment (driven by momentum exchange) and balance of momentum reduce pressure in the zone of sub-atmospheric pressure 212. This combination of effects is enhanced by the expansion and an oblique shock interaction in region 213, which assists in preventing back-flow and separates the low-pressure region 212 from the outlet (far right hand side in FIG. 16) of the conduit 210 at atmospheric pressure. Pressure in the zone of sub-atmospheric pressure 212 is reduced to less than atmospheric pressure and the Inventors have observed that it can be less than 10 kPa absolute.

Pressure equalisation between the zone of sub-atmospheric pressure 212 and atmosphere 226 is prevented when the conduit diameter and length (or shape of the conduit more generally) are such that the jet 200 and internal wall of the conduit 228 interact in such a way as to effectively close the pathway for pressure to equalise to atmosphere. As a secondary effect this may cause a flow recirculation in the zone of sub-atmospheric pressure 212 and is bounded by the face 214 of the exit end of the nozzle 214, the internal wall 228 of the conduit 210 and the boundary of the supersonic jet 200 from the nozzle exit 216 to region 213, where it interacts with the internal wall of the conduit 228. The ability for pressure in the zone of sub-atmospheric pressure 212 to equalise to atmosphere 226 is reduced as the interaction of the jet and the conduit wall increases. Pressure equalisation is prevented when the interaction of the jet 200 and the conduit wall 228 becomes strong enough, e.g. at region 213, to close or “seal off” a pathway for air to enter the zone of sub-atmospheric pressure from outside the conduit. When this occurs flow recirculation in the zone of sub-atmospheric pressure can begin to occur.

As the ability for pressure equalisation reduces, pressure differential increases. The maximum pressure differential occurs when the air pathway is “sealed” and flow recirculation occurs. Sub-atmospheric pressure is maintained in the zone of sub-atmospheric pressure 212 during blasting, creating a pressure differential 218 to atmosphere acting on the area of the face 214 of the exit end 10 of the nozzle exposed to the zone of sub-atmospheric pressure and producing a constant force 220 acting in the opposite direction to the blast nozzle thrust 224.

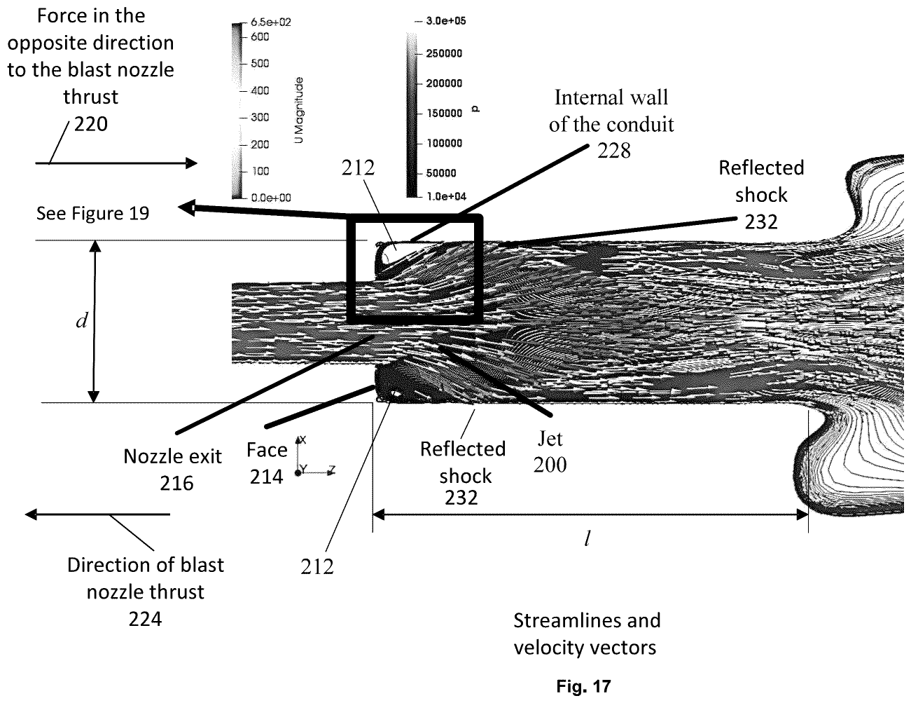

It should be noted that if the geometry of the thrust reduction device is such that the diameter is too large or the length is too short—not in accordance with the design disclosed, or the operating pressure is too low, this will result in the interaction of the expansion and the oblique shock of the jet 200 with the internal wall of the conduit 228 to weaken, and entrainment along the conduit wall from the conduit outlet will begin to occur. Pressure in the zone of sub-atmospheric pressure 212 remains sub-atmospheric and will increase as entrainment increases. The resultant pressure differential in the zone of sub-atmospheric pressure 212 reduces along with the force acting in the opposite direction to the blast nozzle thrust 220. Blast Nozzle thrust reduction force (indicated by arrow 220 in FIG. 17) will continue to occur with reducing effect as pressure in the zone of sub-atmospheric pressure 212 increases.

Referring now to FIG. 17, a CFD simulation is illustrated which has demonstrated that a jet 200 produced by a #6 nozzle operating at inlet pressure of 100 psi expands to interact with an inner wall of a conduit 228 with an internal diameter d=23.5 mm and a length l=60 mm. Expansion commences immediately after the exit of the nozzle 216 resulting in a subsequent increase in fluid velocity and reduction of fluid density of the jet 200 as it travels along the conduit 228.

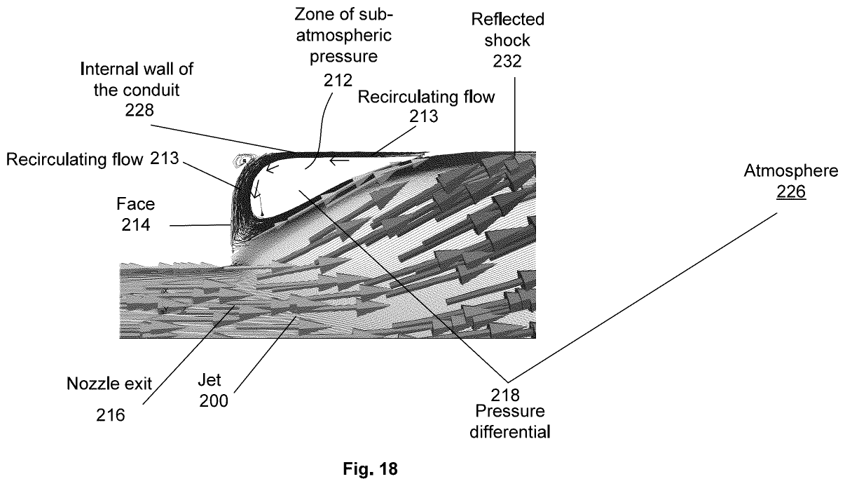

With reference to FIG. 18, the simulations have shown that one way to create the low pressure region is to ensure that the jet 200 interacts with the internal wall of the conduit 228 to produce a reflected shock 232 that effectively seals off the zone of sub-atmospheric pressure 212 causing a recirculating flow 213 within the zone 212 and so preventing pressure equalisation with atmosphere 226 so that a pressure differential 218 develops between atmosphere 226 and the zone of sub-atmospheric 212 The thrust reduction force 220 acts on the area of the face 214 of the nozzle exit 216, which is exposed to the zone of sub-atmospheric pressure 212. The thrust reduction force 220 is in the opposite direction to the blast nozzle thrust 224 and so reduces the effect of the blast nozzle thrust 224 on an operator holding the blast nozzle 224 during use.

The magnitude of the thrust reduction force 220 is dependent on operating inlet pressure, nozzle exit diameter, surface area of the face of the nozzle exit exposed to the zone of sub-atmospheric pressure, geometry of the area of the conduit immediately connected to the exit of the nozzle and can be approximated using the following formula:

Thrust reduction force=(P_atmospheric−P_end)*(Area_conduit_internal−Area_nozzle_exit internal) where P_end is the pressure measured on the face of the nozzle exit, i.e. the pressure in the zone of sub-atmospheric pressure 212. It should be noted that the face of the nozzle exit 214 need not be perpendicular to the longitudinal axis of the conduit of the thrust reducer in order for the sub-atmospheric zone 212 to arise. The face of the corner of the nozzle exit 214 needs to be sufficiently sharp at this location so that an expansion fan forms and creates a sub-atmospheric pressure zone adjacent to the face of the nozzle exit when operated with the thrust reduction device fitted. This sub- atmospheric pressure zone is required for the first expansion wave to form enabling the development of the desired flow pattern described above. This will be achieved by a “rectangular/radial” face. However, the same will also be true for a backwards sloped face and some forward sloping faces. The thrust reduction effect effect will stop once the face becomes so far forward sloping that the thrust reduction device simply becomes an extension of the nozzle, that is a continuation of the expanding section. In this case the expansion will continue, or the flow will separate without the formation of a discrete low-pressure region. Having a near rectangular face is likely to be favourable for thrust reduction when operated at pressures greater than P*, as it makes establishment of the sub atmospheric pressure zone favourable and it is easy to manufacture.

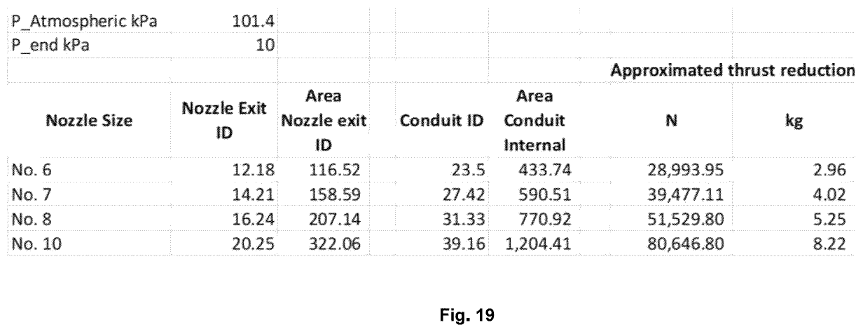

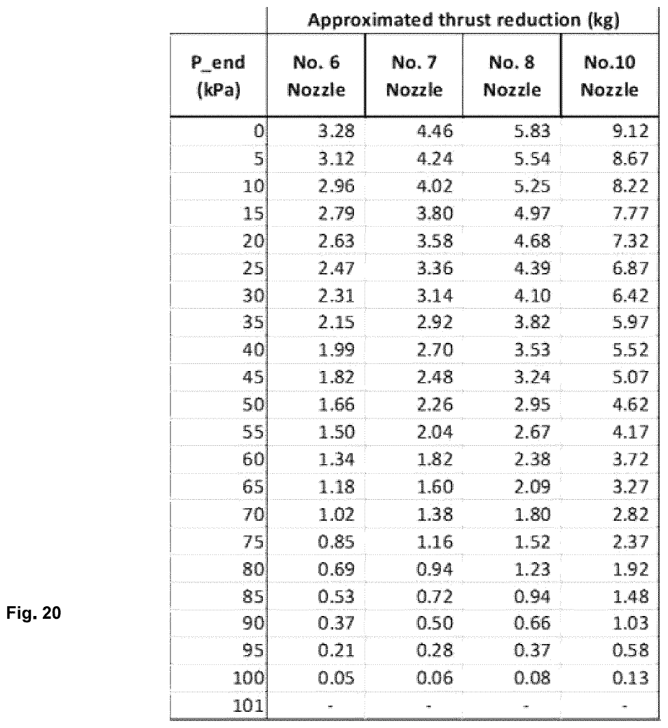

Approximated thrust reduction force 220 for standard size nozzles when Pend takes an exemplary pressure of 10 kPa (absolute), as observed in simulations is shown below. Note, 10 kPa (absolute) is an exemplary value only to illustrate the thrust reduction potential. Reduction in thrust force based on P_end=10 kPa (absolute) for different nozzle sizes are set out in the table in FIG. 19. While minimum Pend results in a higher thrust reduction, different levels of P_end will be obtained as the thrust reduction device geometry, diameter and length are varied. FIG. 20 shows thrust reduction force for various standard nozzle sizes with conduit internal diameters as listed in FIG. 19, and with differing levels of P_end.

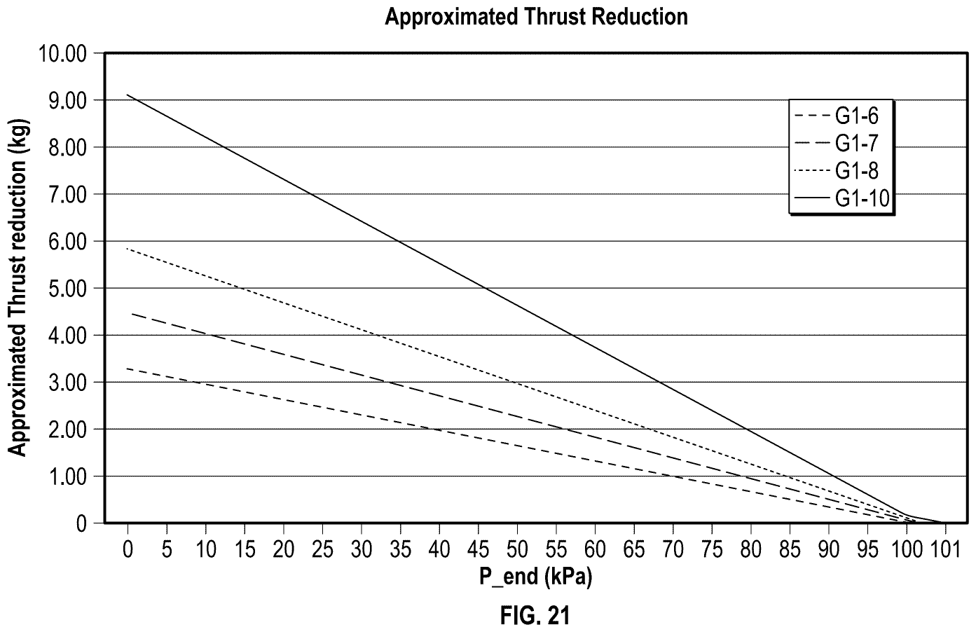

FIG. 21 is a graph of approximated thrust reduction forces for various P_end pressure by nozzle size shown in the table of FIG. 20.

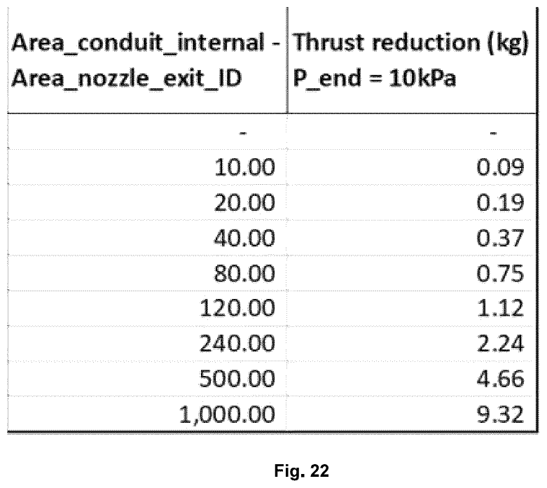

It follows that thrust reduction is also increased as the surface area exposed to P_end is increased (i.e. Area_conduit_internal−Area_nozzle_exit_internal)—as shown in the table of FIG. 22.

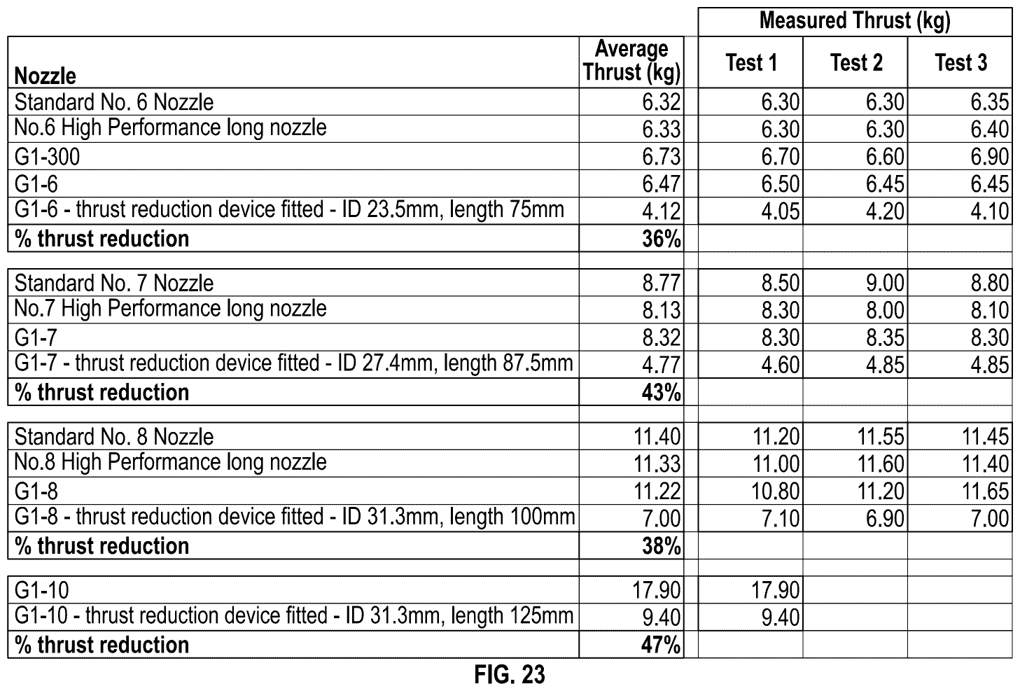

Results of field experiments are consistent with the above hypothesis. The table of FIG. 23 shows demonstrated thrust reduction for a convergent-divergent nozzle operating at an inlet pressure of 100 psi and connected to a thrust reduction apparatus as described herein. Results indicate nozzle thrust reduction of between 36% and 47% across the nozzle sizes tested.

Through simulation and experiment the Inventors have established that the mechanism for thrust reduction changes as the nozzle length reduces and/or conduit inner diameter increases.

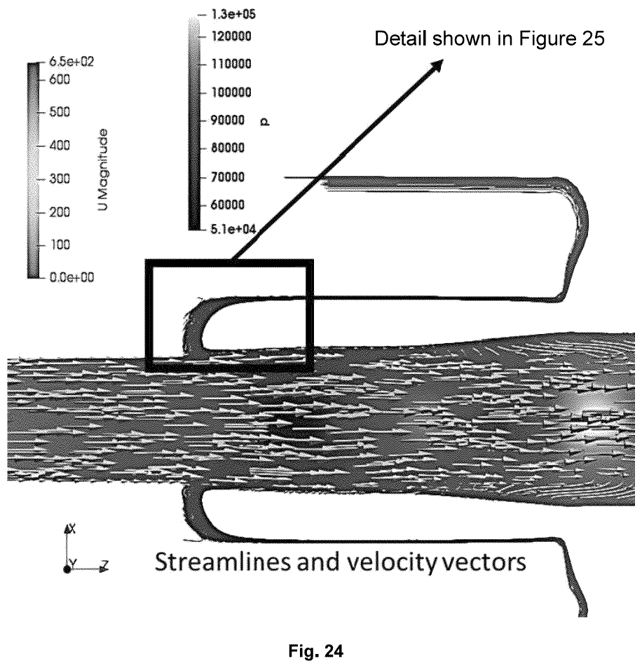

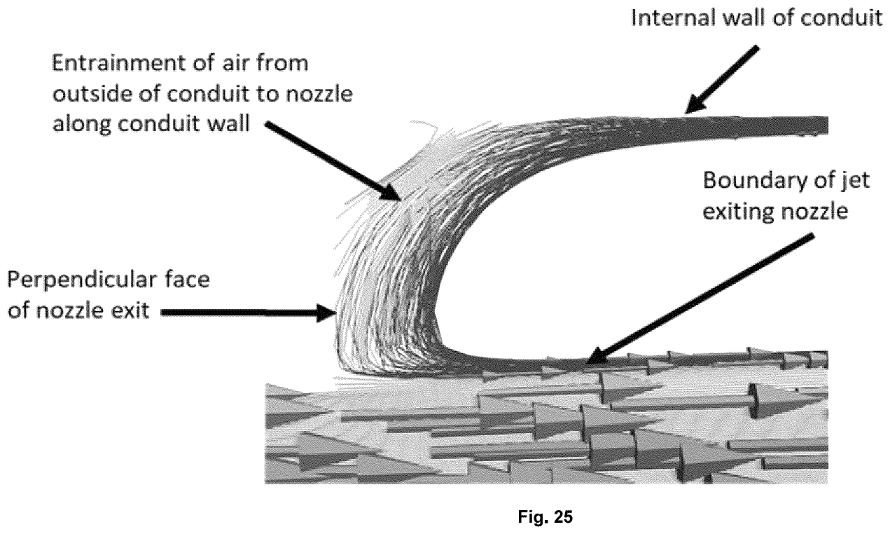

Simulations have shown that this takes place at an internal diameter of 23.5 mm and a length of 40 mm for number 6 nozzles operating at inlet pressure of 80 psi, and experiments have shown this to occur at a length of 35 mm for operation at inlet pressure of 100 psi. After this point density and pressure of air in the zone of sub-atmospheric pressure still reduces however the boundary of the jet no longer fully expands to strongly interact with the internal wall of the conduit (see FIG. 24). However, a reduction in thrust (e.g., 5% for the exemplary data shown in the table) still exists. As a result, pressure in the zone of sub-atmospheric pressure is reduced, but not to the extent as when flow recirculation occurs.

Furthermore, as the jet exiting the nozzle expands to interact with the thrust reduction device wall, other flow features that result in nozzle silencing occur, namely 1 ½ shock cells are created in the jet inside the thrust reduction device, no shock cells are created in the jet outside the thrust reduction device and the jet exits the thrust reduction device with an established turbulent shear layer, and the jet entrains an annular jet that sits around the outside of the core jet, and this is desirable for reducing noise.

To maximise performance (maximum thrust reduction and cleaning rate) at different operating pressures it is necessary to adjust the dimensions of the thrust reduction device. That is, while a thrust reduction device designed for 100 psi (nominal design point) will still provide thrust reduction at 80 psi, to achieve maximum performance the thrust reduction device dimensions should be adjusted (shorter and smaller diameter).

Thrust reduction device geometries for effective thrust reduction are set out in Table 3 to Table 11 for a nozzle with an area ratio of 1.63±5%. The tables show examples of preferred thrust reduction device lengths and diameters, diameters and minimum lengths for effective thrust reduction for a range of pressures at which thrust reduction becomes effective (P*).

TABLE 3
Preferred Thrust reduction device diameter and length and minimum Thrust reduction device
lengths for effective thrust reduction for a nozzle with P_design of 100psi and operated at 100 psi

| | Preferred | Preferred | Minimum Length for |
|---|---|---|---|
| Nozzle | Diameter | Length | effective Thrust |
| Size | (mm) | (mm) | reduction (mm) |
| No. 3 | 11.8 | 37.5 | 23.5 |
| No. 4 | 15.7 | 50.0 | 31.0 |
| No. 5 | 19.6 | 62.5 | 39.0 |
| No. 6 | 23.5 | 75.0 | 46.5 |
| No. 7 | 27.4 | 87.5 | 54.5 |
| No. 8 | 31.3 | 100.0 | 62.0 |
| No. 10 | 39.2 | 125.0 | 77.5 |

TABLE 4
Preferred Thrust reduction device diameter
and minimum Thrust reduction device
lengths for effective Thrust reduction for a nozzle
with P_design of 100 psi and operated at 80 psi
For effective operation at supply pressure
P* = 80 psi

| | Preferred | Minimum Length for |
|---|---|---|
| Nozzle | Diameter | effective Thrust |
| Size | (mm) | reduction (mm) |
| No. 3 | 11.8 | 37.0 |
| No. 4 | 15.7 | 49.0 |
| No. 5 | 19.6 | 61.0 |
| No. 6 | 23.5 | 73.5 |
| No. 7 | 27.4 | 85.5 |
| No. 8 | 31.3 | 98.0 |
| No. 10 | 39.2 | 122.0 |

TABLE 5
Preferred Thrust reduction device diameter
and minimum Thrust reduction device
lengths for effective Thrust reduction for a nozzle
with P_design of 100 psi and operated at 120 psi
For effective operation at supply pressure -
P* = 120 psi

| | Preferred | Minimum Length for |
|---|---|---|
| Nozzle | Diameter | effective Thrust |
| Size | (mm) | reduction (mm) |
| No. 3 | 11.8 | 16.0 |
| No. 4 | 15.7 | 21.5 |
| No. 5 | 19.6 | 27.5 |
| No. 6 | 23.5 | 32.0 |
| No. 7 | 27.4 | 37.0 |
| No. 8 | 31.3 | 42.5 |
| No. 10 | 39.2 | 53.0 |

TABLE 6-7
Thrust reduction device diameter
and minimum lengths for effective thrust
reduction for a nozzle with P_design of 100 psi
and operated at 100 psi
For effective operation at supply pressure -
P* = 100 psi

| | | Minimum Length for |
|---|---|---|
| Nozzle | Diameter | effective Thrust |
| Size | (mm) | reduction (mm) |
| No. 3 | 10.0 | 11.0 |
| No. 4 | 13.3 | 15.0 |
| No. 5 | 16.7 | 18.5 |
| No. 6 | 20.0 | 22.0 |
| No. 7 | 23.3 | 25.5 |
| No. 8 | 26.7 | 29.5 |
| No. 10 | 33.3 | 36.5 |

Thrust reduction device diameter and
minimum lengths for effective thrust
reduction for a nozzle with P_design of 100 psi
and operated at 80 psi
For effective operation at supply pressure -
P* = 80 psi

| | | Minimum Length for |
|---|---|---|
| Nozzle | Diameter | effective Thrust |
| Size | (mm) | reduction (mm) |
| No. 3 | 10.0 | 17.5 |
| No. 4 | 13.3 | 23.0 |
| No. 5 | 16.7 | 29.0 |
| No. 6 | 20.0 | 34.5 |
| No. 7 | 23.3 | 40.5 |
| No. 8 | 26.7 | 46.0 |
| No. 10 | 33.3 | 57.5 |

TABLE 8
Thrust reduction device diameter and
minimum lengths for effective Thrust
reduction for a nozzle with P_design of
100 psi and operated at 120 psi
For effective operation at supply pressure -
P* = 120 psi

| | Target | Minimum Length for |
|---|---|---|
| Nozzle | Diameter | effective Thrust |
| Size | (mm) | reduction (mm) |
| No. 3 | 10.0 | 7.5 |
| No. 4 | 13.3 | 10.0 |
| No. 5 | 16.7 | 12.5 |
| No. 6 | 20.0 | 15.0 |
| No. 7 | 23.3 | 17.5 |
| No. 8 | 26.7 | 20.0 |
| No. 10 | 33.3 | 25.0 |

TABLE 9-10
Thrust reduction device diameter
and minimum lengths for effective thrust
reduction for a nozzle with P_design of
100 psi and operated at 100 psi
For effective operation at ideal supply
pressure - P* = 100 psi

| | | Minimum Length |
|---|---|---|
| Nozzle | Diameter | for effective Thrust |
| Size | (mm) | reduction (mm) |
| No. 3 | 13.6 | 43.0 |
| No. 4 | 18.1 | 57.0 |
| No. 5 | 22.6 | 71.5 |
| No. 6 | 27.1 | 85.5 |
| No. 7 | 31.6 | 100.0 |
| No. 8 | 36.1 | 113.5 |
| No. 10 | 45.2 | 142.5 |

Thrust reduction device diameter and
minimum lengths for effective Thrust reduction
for a nozzle with P_design of 100 psi and
operated at 80 psi
For effective operation at supply pressure -
P* = 80 psi

| | | Minimum Length for |
|---|---|---|
| Nozzle | Diameter | effective Thrust |
| Size | (mm) | reduction (mm) |
| No. 3 | 13.6 | 67.5 |
| No. 4 | 18.1 | 90.0 |
| No. 5 | 22.6 | 112.5 |
| No. 6 | 27.1 | 135.5 |
| No. 7 | 31.6 | 157.5 |
| No. 8 | 36.1 | 179.5 |
| No. 10 | 45.2 | 224.5 |

TABLE 11
Thrust reduction device diameter and
minimum lengths for effective thrust
reduction for a nozzle with P_design
of 100 psi and operated at 120 psi
For effective operation at supply
pressure -P *= 120 psi

| | | Minimum |
|---|---|---|
| | Target | Length for |
| Nozzle | Diameter | effective Thrust |
| Size | (mm) | reduction (mm) |
| No. 3 | 13.6 | 29.5 |
| No. 4 | 18.1 | 39.0 |
| No. 5 | 22.6 | 48.5 |
| No. 6 | 27.1 | 58.5 |
| No. 7 | 31.6 | 68.0 |
| No. 8 | 36.1 | 77.5 |
| No. 10 | 45.2 | 97.0 |

Effective Thrust reduction continues to occur at lengths longer than the minimum effective length. The length of the Thrust reduction device above this minimum length is constrained by the practical constraints for the blasting application.

The following table—Table 12 describes the preferred Thrust reduction device geometry, meaning it gives robust performance and considers other factors relevant to blasting along with effective thrust reduction. The following two examples in the table correspond to relevant geometries that provide effective thrust reduction when operated at 100 psi (P_Design inlet pressure). This provides coverage of relevant geometries that would be effective and that could be considered useful in a blasting application when operated at the 100 psi nozzle inlet pressure. This provides a lower and upper bound to the Thrust reduction device geometries that could be considered effective when blasting using a nozzle with an area ratio A/A* of 1.63±5%.

TABLE 12

| | Preferred Thrust | | | | | |
|---|---|---|---|---|---|---|
| | reduction device | | Alternate Thrust | | | |
| | dimensions when | | reduction device | | Alternate Thrust reduction | |
| | the nozzle is | | dimensions when the | | device dimensions when | |
| | operated | | nozzle is operated at | | the nozzle is operated at | |
| | P_Design = 100 psi | | P_Design = 100 psi | | P_Design 100 = psi | |
| Nozzle | Length | Diameter | Length | Diameter | Length | Diameter |
| Size | (mm) | (mm) | (mm) | (mm) | (mm) | (mm) |
| No. 3 | 37.5 | 11.75 | 67.5 | 13.5 | 17.5 | 10.0 |
| No. 4 | 50 | 15.67 | 90.0 | 18.0 | 23.0 | 13.0 |
| No. 5 | 62.5 | 19.58 | 112.5 | 22.5 | 29.0 | 16.5 |
| No. 6 | 75 | 23.5 | 135.0 | 27.1 | 34.5 | 20.0 |
| No. 7 | 87.5 | 27.1 | 157.5 | 31.5 | 40.5 | 23.0 |
| No. 8 | 100 | 31.33 | 179.5 | 36.0 | 46.0 | 26.5 |
| No. 10 | 125 | 39.16 | 224.5 | 45.0 | 57.5 | 33.0 |

Preferred and alternate Thrust reduction device geometries for effective Thrust
reduction for use with nozzles with an area ratio A/A* of 1.63 ± 5 and an P_design pressure of
100psi where effective Thrust reduction commences at 80psi (ie P* = 80 psi).

It is known that abrasive blasting nozzles can have a range of area ratios A/A* other than 1.63 and can be operated at various inlet pressures. The following tables contain dimensions for effective Thrust reduction devices for nozzles with two different area ratios A/A* operated at at range of inlet pressures including 80 psi, 100 psi, 120 psi and 130 psi.

Thrust reduction device geometries for effective thrust reduction are set out in Table 13 to Table 17 for a nozzle with an area ratio of 1.42±5%.

TABLE 13
Thrust reduction device diameter and minimum
lengths for effective thrust reduction
for a nozzle with P_design of 81 psi and
operated at 80 psi
For effective operation at supply pressure -
P* = 80 psi

| | | Minimum Length |
|---|---|---|
| | | for effective |
| Nozzle | Diameter | Thrust reduction |
| Size | (mm) | (mm) |
| No. 3 | 10.95 | 18.0 |
| No. 4 | 14.60 | 24.0 |
| No. 5 | 18.26 | 30.0 |
| No. 6 | 21.91 | 36.0 |
| No. 7 | 25.56 | 42.0 |
| No. 8 | 29.21 | 48.0 |
| No. 10 | 36.51 | 60.0 |

TABLE 14
Thrust reduction device diameter and
minimum lengths for effective thrust
reduction for a nozzel with P_design
of 81 psi and operated at 100 psi
For effective operation at supply
pressure -P* = 100 psi

| | | Minimum |
|---|---|---|
| | | Length for |
| Nozzle | Diameter | effective Thrust |
| Size | (mm) | reduction (mm) |
| No. 3 | 10.95 | 11.5 |
| No. 4 | 14.60 | 15.5 |
| No. 5 | 18.26 | 19.0 |
| No. 6 | 21.91 | 23.0 |
| No. 7 | 25.56 | 26.5 |
| No. 8 | 29.21 | 30.5 |
| No. 10 | 36.51 | 38.0 |

TABLE 15
Thrust reduction device diameter and
minimum lengths for effective thrust
reduction for a nozzle with P_design
of 81 psi and operated at 80 psi
For effective operation at supply
pressure -P* = 80 psi

| | | Minimum |
|---|---|---|
| | | Length for |
| Nozzle | Diameter | effective Thrust |
| Size | (mm) | reduction (mm) |
| No. 3 | 9.31 | 8.5 |
| No. 4 | 12.41 | 11.5 |
| No. 5 | 15.51 | 14.0 |
| No. 6 | 18.61 | 17.0 |
| No. 7 | 21.72 | 19.5 |
| No. 8 | 24.82 | 22.5 |
| No. 10 | 31.02 | 28.0 |

TABLE 16
Thrust reduction device diameter and
minimum lengths for effective thrust
reduction for a nozzle with P_design
of 81 psi and operated at 80 psi
For effective operation at supply
pressure -P *= 80 psi

| | | Minimum |
|---|---|---|
| | | Length for |
| Nozzle | Diameter | effective Thrust |
| Size | (mm) | reduction (mm) |
| No. 3 | 12.60 | 33.0 |
| No. 4 | 16.80 | 44.0 |
| No. 5 | 21.00 | 55.0 |
| No. 6 | 25.20 | 65.5 |
| No. 7 | 29.40 | 76.5 |
| No. 8 | 33.60 | 87.5 |
| No. 10 | 42.00 | 109.5 |

TABLE 17
Thrust reduction device diameter and
minimum lengths for effective thrust
reduction for a nozzle with P_design
of 81 psi and operated at 100 psi
For effective operation at supply
pressure -P *= 100 psi

| | | Minimum |
|---|---|---|
| | | Length for |
| Nozzle | Diameter | effective Thrust |
| Size | (mm) | reduction (mm) |
| No. 3 | 12.60 | 21.0 |
| No. 4 | 16.80 | 28.0 |
| No. 5 | 21.00 | 35.5 |
| No. 6 | 25.20 | 41.5 |
| No. 7 | 29.40 | 48.5 |
| No. 8 | 33.60 | 55.5 |
| No. 10 | 42.00 | 69.15 |

Thrust reduction device geometries for effective thrust reduction are set out in Table 18 to Table 22 for a nozzle with an area ratio of 2.1±5%.

TABLE 18
Thrust reduction device diameter and minimum lengths for effective
thrust reduction for a nozzle with P_design of 168 psi and
operated at 100 psi
For effective operation at supply pressure-P* = 100 psi

| | | Minimum Length for |
|---|---|---|
| Nozzle | Diameter | effective Thrust reduction |
| Size | (mm) | (mm) |
| No. 3 | 13.32 | 78.5 |
| No. 4 | 17.76 | 104.5 |
| No. 5 | 22.20 | 130.5 |
| No. 6 | 26.64 | 157.0 |
| No. 7 | 31.08 | 183.0 |
| No. 8 | 35.52 | 209.0 |
| No. 10 | 44.40 | 261.0 |

TABLE 19
Thrust reduction device diameter and minimum lengths for effective
thrust reduction for a nozzle with P_design of 168 psi and
operated at 120 psi
For effective operation at supply pressure-P* = 120 psi

| | | Minimum Length for |
|---|---|---|
| Nozzle | Diameter | effective Thrust reduction |
| Size | (mm) | (mm) |
| No. 3 | 13.32 | 53.5 |
| No. 4 | 17.76 | 71.5 |
| No. 5 | 22.20 | 89.0 |
| No. 6 | 26.64 | 107.0 |
| No. 7 | 31.08 | 125.0 |
| No. 8 | 35.52 | 142.5 |
| No. 10 | 44.40 | 178.0 |

TABLE 20
Thrust reduction device diameter and minimum lengths for effective
thrust reduction for a nozzle with P_design of 168 psi and
operated at 130 psi
For effective operation at supply pressure-P* = 130 psi

| | | Minimum Length for |
|---|---|---|
| Nozzle | Diameter | effective Thrust reduction |
| Size | (mm) | (mm) |
| No. 3 | 13.32 | 45.5 |
| No. 4 | 17.76 | 60.5 |
| No. 5 | 22.20 | 75.5 |
| No. 6 | 26.64 | 90.5 |
| No. 7 | 31.08 | 105.5 |
| No. 8 | 35.52 | 120.5 |
| No. 10 | 44.40 | 150.5 |

TABLE 21
Thrust reduction device diameter and minimum lengths for effective
thrust reduction for a nozzle with P_design of 168 psi and
operated at 100 psi
For effective operation at supply pressure-P* = 100 psi

| | | Minimum Length for |
|---|---|---|
| Nozzle | Diameter | effective Thrust reduction |
| Size | (mm) | (mm) |
| No. 3 | 11.32 | 37.0 |
| No. 4 | 15.09 | 49.0 |
| No. 5 | 18.86 | 61.0 |
| No. 6 | 22.64 | 73.5 |
| No. 7 | 26.41 | 85.5 |
| No. 8 | 30.18 | 98.0 |
| No. 10 | 37.73 | 122.0 |

TABLE 22
Thrust reduction device diameter and minimum lengths for effective
thrust reduction for a nozzle with P_design of 168 psi and
operated at 120 psi
For effective operation at supply pressure-P* = 120 psi

| | | Minimum Length for |
|---|---|---|
| Nozzle | Diameter | effective Thrust reduction |
| Size | (mm) | (mm) |
| No. 3 | 11.32 | 25.0 |
| No. 4 | 15.09 | 33.5 |
| No. 5 | 18.86 | 42.5 |
| No. 6 | 22.64 | 50.0 |
| No. 7 | 26.41 | 58.5 |
| No. 8 | 30.18 | 66.5 |
| No. 10 | 37.73 | 83.5 |

The inventors have tested the effectiveness of thrust reduction devices when operated at inlet pressures other than the ideal supply pressure for the nozzle exit to throat ratio (A/A*) of 1.63 and have found Thrust reduction devices with dimensions as set out in Tables 3 to 12 to be effective when operated at the inlet pressures shown.

Additionally, the inventors have tested thrust reduction device designs for use with nozzle area ratios (A/A*) other than 1.63, including 1.42 and 2.1 and have confirmed thrust reduction device geometries as set out in Tables 13 to 22 to be effective when operated at the inlet pressures shown.

It should be noted that stated thrust reduction device dimensions for operation at standard atmospheric conditions at sea level. Allowance should be made to accommodate differences in atmospheric pressure, temperature and humidity expected during operation.

Effective thrust reduction continues to occur at lengths above the minimum effective length. The length of the thrust reduction device above this minimum length is constrained by the practical constraints for the blasting application.

The Inventors have found a thrust reducer having a body of sufficient length to extend a distance of at least one shock diamond (expansion wave inside the thrust reduction device) from the outlet of the blast nozzle in use produces the thrust reduction effect. By making the body longer, so that it encapsulates at least the first three shock diamonds of a substantially ideally expanded jet from a nozzle without a thrust reduction device fitted, the Inventors have also found that the operational noise, particularly “screech” of the blast jet is substantially reduced so that in that case the thrust reduction apparatus operates both to reduce thrust and also as a silencer.

Additionally, through experiment the inventors have shown that a thrust reduction device with an internal ramp as shown in FIG. 29,will increase the thrust reduction effect when operated at or near to the ideal supply pressure (P_design)+−20%—for a given nozzle area ratio.

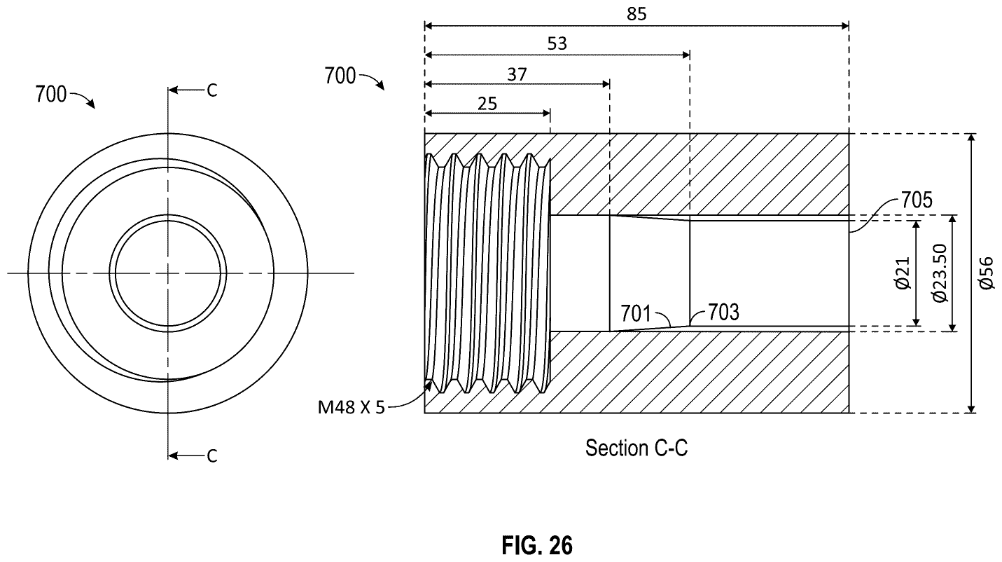

FIG. 26 depicts a rear end view (at left) and a longitudinal cross sectional view (at right) of a thrust reducer 700 that includes a ramp 701 and step 703 at an axial location downstream of the nozzle exit 705. The ramp is positioned to mostly not interfere with the internal shocks generated by an effective thrust reducer. The inclusion creates further oblique shocks and expansions that will form high pressure regions on the up-stream side of the ramp and low pressure regions on the downstream side of the ramp that together augment the anti-thrust force. These extra further expansion assists in further improving noise reduction and thrust reduction by introducing a second recirculation region after the step, in a similar manner to that of the main thrust reducer body. This further reduces the pressure in the body which assists in thrust reduction and increases overall thrust reduction device performance through improving one or more of the primary thrust reduction mechanisms (i.e. increasing the antithrust force, the turbulence in the shear layer, increasing the integrity of the annular jet and improving creation of jet expansion).

In compliance with the statute, the subject matter disclosed herein has been described in language more or less specific to structural or methodical features. The term “comprises” and its variations, such as “comprising” and “comprised of” is used throughout in an inclusive sense and not to the exclusion of any additional features. It is to be understood that the disclosure is not limited to specific features shown or described since the means herein described comprises preferred forms of putting the disclosed subject matter into effect.

1. A blast nozzle thrust reduction blasting system comprising:
a source of blasting gas in a predetermined pressure range with abrasive particles entrained therein;
a nozzle including
a nozzle inlet for connection to the source of blasting gas,
a nozzle outlet for emission of the blasting gas,
a nozzle conduit from the nozzle inlet to the nozzle outlet including a throat therebetween with a ratio of area of the nozzle outlet to area of the throat selected to emit the blasting gas from the nozzle outlet to produce a supersonic jet;
a thrust reducer connectable to the nozzle, to receive the supersonic jet exiting the nozzle, the thrust reducer comprising a body with a thrust reducer conduit therethrough, the body being of sufficient length and diameter to cause a flow condition of the jet received from the nozzle outlet to be modified such that a zone of sub-atmospheric pressure forms adjacent a face of the outlet of the nozzle whereby a pressure differential arises between the zone of sub-atmospheric pressure and surrounding atmosphere thereby creating an anti-thrust force in opposition to thrust of the nozzle.

2. The blast nozzle thrust reduction blasting system of claim 1, wherein the thrust reducer body includes a coupling portion arranged to connect to a portion of the nozzle adjacent the nozzle outlet and a thrust reduction portion defining the thrust reducer conduit, wherein the thrust reduction portion extends from the coupling portion to a thrust reducer outlet of the thrust reducer.

3. The blast nozzle thrust reduction blasting system of claim 2, wherein the predetermined pressure range is 80 psi or greater.

4. The blast nozzle thrust reduction blasting system of claim 3, wherein the nozzle has a nozzle exit area to nozzle throat area ratio (A/A*) of 1.63±5%.

5. The blast nozzle thrust reduction blasting system of claim 4, wherein:
the nozzle comprises a #3 nozzle and the thrust reducer has a thrust reducer outlet diameter of 11.75±2.5% mm and a thrust reduction portion length of 37.50±5% mm; or
the nozzle comprises a #4 nozzle and the thrust reducer has a thrust reducer outlet diameter of 15.67±2.5% mm and a thrust reduction portion length of 50.00±5% mm; or
the nozzle comprises a #5 nozzle and the thrust reducer has a thrust reducer outlet diameter of 19.58±2.5% mm and a thrust reduction portion length of 62.50±5% mm; or
the nozzle comprises a #6 nozzle and the thrust reducer has a thrust reducer outlet diameter of 23.50±2.5% mm and a thrust reduction portion length of 75.00±5% mm; or
the nozzle comprises a #7 nozzle and the thrust reducer has a thrust reducer outlet diameter of 27.1±2.5% mm and a thrust reduction portion length of 87.50±5% mm; or
the nozzle comprises a #8 nozzle and the thrust reducer has a thrust reducer outlet diameter of 31.33±2.5% mm and a thrust reduction portion length of 100±5% mm; or
the nozzle comprises a #10 nozzle and the thrust reducer has a thrust reducer outlet diameter of 39.16±2.5% mm and a thrust reduction portion length of 125±5% mm.

6-11. (canceled)

12. The blast nozzle thrust reduction blasting system of claim 3, wherein the nozzle has a nozzle exit area to nozzle throat area ratio (A/A*) of 1.63±5%, and wherein the nozzle comprises a nozzle with nozzle size as set out in the leftmost column of the following table and the thrust reducer has a thrust reducer outlet diameter as set out in the following table for the nozzle size and thrust reduction portion length at least as long as set out in the following table for the nozzle size:

| Nozzle | Thrust reduction | Outlet |
|---|---|---|
| Size | portion length (mm) | Diameter (mm) |
| No. 3 | 67.5 | 13.5 |
| No. 4 | 90.0 | 18.0 |
| No. 5 | 112.5 | 22.5 |
| No. 6 | 135.0 | 27.1 |
| No. 7 | 157.5 | 31.5 |
| No. 8 | 179.5 | 36.0 |
| No. 10 | 224.5 | 45.0; |

or
wherein the nozzle comprises a nozzle with nozzle size as set out in the leftmost column of the following table and the thrust reducer has a thrust reducer outlet diameter as set out in the following table for the nozzle size and thrust reduction portion length at least as long as set out in the following table for the nozzle size:

| Nozzle | Thrust reduction | Outlet Diameter |
|---|---|---|
| Size | portion length (mm) | (mm) |
| No. 3 | 17.5 | 10.0 |
| No. 4 | 23.0 | 13.0 |
| No. 5 | 29.0 | 16.5 |
| No. 6 | 34.5 | 20.0 |
| No. 7 | 40.5 | 23.0 |
| No. 8 | 46.0 | 26.5 |
| No. 10 | 57.5 | 33.0; |

or
wherein the nozzle has a nozzle exit area to nozzle throat area ratio (A/A*) of 1.42±5%, and wherein the nozzle comprises a nozzle with a nozzle size as set out in the leftmost column of the following table and the thrust reducer has a thrust reducer outlet diameter as set out in the following table for the nozzle size and thrust reduction portion length at least as long as set out in the following table for the nozzle size:

| Nozzle | Outlet | Thrust reduction |
|---|---|---|
| Size | Diameter (mm) | portion length (mm) |
| No. 3 | 10.95 | 18.0 |
| No. 4 | 14.60 | 24.0 |
| No. 5 | 18.26 | 30.0 |
| No. 6 | 21.91 | 36.0 |
| No. 7 | 25.56 | 42.0 |
| No. 8 | 29.21 | 48.0 |
| No. 10 | 36.51 | 60.0; |

or
wherein the nozzle has a nozzle exit area to nozzle throat area ratio (A/A*) of 2.1±5%, and wherein the nozzle comprises a nozzle with a nozzle size as set out in the leftmost column of the following table and the thrust reducer has a thrust reducer outlet diameter as set out in the following table for the nozzle size and thrust reduction portion length at least as long as set out in the following table for the nozzle size:

| Nozzle | Outlet | Thrust reduction |
|---|---|---|
| Size | Diameter (mm) | portion length (mm) |
| No. 3 | 13.32 | 78.5 |
| No. 4 | 17.76 | 104.5 |
| No. 5 | 22.20 | 130.5 |
| No. 6 | 26.64 | 157.0 |
| No. 7 | 31.08 | 183.0 |
| No. 8 | 35.52 | 209.0 |
| No. 10 | 44.40 | 261.0. |

13-17. (canceled)

18. The blast nozzle thrust reduction blasting system of claim 2, wherein the predetermined pressure range is 80 psi or greater and the nozzle has an A/A* area ratio of 1.63±5%, and wherein the nozzle comprises a nozzle with a nozzle size as set out in the leftmost column of the following table and the thrust reducer has a thrust reducer outlet diameter as set out in the following table for the nozzle size and thrust reduction portion length ranging between the preferred length and the minimum length for effective thrust reduction as set out in the following table for the nozzle size:

| | Preferred | Preferred | Minimum Length for |
|---|---|---|---|
| Nozzle | Diameter | Length | effective thrust |
| Size | mm | mm | reduction (mm) |
| No. 3 | 11.8 | 37.5 | 23.5 |
| No. 4 | 15.7 | 50.0 | 31.0 |
| No. 5 | 19.6 | 62.5 | 39.0 |
| No. 6 | 23.5 | 75.0 | 46.5 |
| No. 7 | 27.4 | 87.5 | 54.5 |
| No. 8 | 31.3 | 100.0 | 62.0 |
| No. 10 | 39.2 | 125.0 | 77.5. |

19. The blast nozzle thrust reduction blasting system of claim 2, wherein the predetermined pressure range is 80 psi to 120 psi and the nozzle has an A/A* area ratio of 1.63±5% wherein:
the nozzle comprises a #3 nozzle and herein the length of the thrust reducer is between 7.5 mm and 67.5 mm and the diameter of the thrust reducer is between 10.00 mm and 13.5 mm; or
the nozzle comprises a #4 nozzle and the length of the thrust reducer is between 10.0 mm and 90 mm and the diameter of the thrust reducer is between 13 mm and 18 mm; or
the nozzle comprises a #5 nozzle and the length of the thrust reducer is between 12.5 mm and 112.5 mm and the diameter of the thrust reducer is between 12.5 mm and 22.5 mm; or
the nozzle comprises a #6 nozzle and the length of the thrust reducer is between 15 mm and 135.0 mm and the diameter of the thrust reducer is between 20 mm and 27.1 mm; or
the nozzle comprises a #7 nozzle and the length of the thrust reducer is between 17.5 mm and 157.5 mm and the diameter of the thrust reducer is between 23 mm and 31.5 mm; or
the nozzle comprises a #8 nozzle and the length of the thrust reducer is between 20.0 mm and 179.5 mm and the diameter of the thrust reducer is between 26.5 mm and 36.0 mm; or
the nozzle comprises a #10 nozzle and the length of the thrust reducer is between 25 mm and 224.5 mm and the diameter of the thrust reducer is between 33.0 mm and 45.0 mm.

20-26. (canceled)

27. The blast nozzle thrust reduction blasting system of claim 1, wherein the thrust reducer body includes an inlet body portion that is removably received within the thrust reducer conduit of the thrust reducer body.

28. The blast nozzle thrust reduction blasting system of claim 27, wherein the inlet body portion comprises a removable sleeve that is removably received within the body.

29. A method for reducing blast nozzle thrust of a blast nozzle, the method comprising:
providing a blast nozzle including a nozzle body with a nozzle conduit extending from a nozzle inlet to a nozzle outlet with a throat of the conduit therebetween, a ratio of outlet area to throat area constraining the nozzle to produce a supersonic jet;
connecting a source of blasting gas sufficient to produce a supersonic jet at the nozzle outlet; and
coupling a thrust reducer to an outlet end of the nozzle,
the thrust reducer comprising a body with a thrust reducer conduit therethrough, the body being of sufficient length and diameter to cause a flow condition of the jet received from the nozzle outlet to be modified such that a zone of sub-atmospheric pressure forms adjacent a face of the outlet of the nozzle whereby a pressure differential arises between the zone of sub-atmospheric pressure and surrounding atmosphere thereby creating an anti-thrust force in opposition to thrust of the nozzle.

30-56. (canceled)

57. A thrust reducer arranged to connect to and reduce operational thrust of a blast nozzle, the blast nozzle comprising a body with a conduit therethrough extending from a nozzle inlet for connection to a source of blasting gas and a nozzle outlet for emitting a jet, the nozzle conduit including a throat between the nozzle inlet and the nozzle outlet, the nozzle outlet having a nozzle outlet area and the throat having a throat area, a ratio of the nozzle outlet area to the throat area constraining the nozzle to produce a supersonic jet,
the thrust reducer comprising a body with a thrust reducer conduit therethrough, the body being of sufficient length and diameter to cause a flow condition of the jet received from the nozzle outlet to be modified such that a zone of sub-atmospheric pressure forms adjacent a face of the outlet of the nozzle whereby a pressure differential arises between the zone of sub-atmospheric pressure and surrounding atmosphere thereby creating an anti-thrust force in opposition to thrust of the nozzle.

58. The thrust reducer of claim 57, wherein the thrust reducer body includes a coupling portion arranged to connect to a portion of the nozzle adjacent the nozzle outlet and a thrust reduction portion defining the thrust reducer conduit, wherein the thrust reduction portion extends from the coupling portion to a thrust reducer outlet of the thrust reducer.

59. The thrust reducer of claim 58, wherein the predetermined pressure range is 80 psi or greater.

60. The thrust reducer of claim 59, wherein the nozzle has a nozzle exit area to nozzle throat area ratio (A/A*) of 1.63±5%.

61. The thrust reducer of claim 60, wherein:
the nozzle comprises a #3 nozzle and the thrust reducer has a thrust reducer outlet diameter of 11.75±2.5% mm and a thrust reduction portion length of 37.50±5% mm; or
the nozzle comprises a #4 nozzle and the thrust reducer has a thrust reducer outlet diameter of 15.67±2.5% mm and a thrust reduction portion length of 50.00±5% mm; or
the nozzle comprises a #5 nozzle and the thrust reducer has a thrust reducer outlet diameter of 19.58±2.5% mm and a thrust reduction portion length of 62.50±5% mm; or
the nozzle comprises a #6 nozzle and the thrust reducer has a thrust reducer outlet diameter of 23.50 ±2.5% mm and a thrust reduction portion length of 75.00±5% mm; or
the nozzle comprises a #7 nozzle and the thrust reducer has a thrust reducer outlet diameter of 27.1±2.5% mm and a thrust reduction portion length of 87.50±5% mm; or
the nozzle comprises a #8 and the thrust reducer has a thrust reducer outlet diameter of 31.33±2.5% mm and a thrust reduction portion length of 100±5% mm; or
the nozzle comprises a #10 nozzle and the thrust reducer has a thrust reducer outlet diameter of 39.16±2.5% mm and a thrust reduction portion length of 125±5% mm.

62-67. (canceled)

68. The thrust reducer of claim 59, wherein the nozzle has a nozzle exit area to throat area ratio (A/A*) of 1.63±5%, and wherein:
the nozzle comprises a nozzle with nozzle size as set out in the leftmost column of the following table and the thrust reducer has a thrust reducer outlet diameter as set out in the following table for the nozzle size and thrust reduction portion length at least as long as set out in the following table for the nozzle size:

| Nozzle | Thrust reduction | Outlet |
|---|---|---|
| Size | portion length (mm) | Diameter (mm) |
| No. 3 | 67.5 | 13.5 |
| No. 4 | 90.0 | 18.0 |
| No. 5 | 112.5 | 22.5 |
| No. 6 | 135.0 | 27.1 |
| No. 7 | 157.5 | 31.5 |
| No. 8 | 179.5 | 36.0 |
| No. 10 | 224.5 | 45.0; |

or
the nozzle comprises a nozzle with nozzle size as set out in the leftmost column of the following table and the thrust reducer has a thrust reducer outlet diameter as set out in the following table for the nozzle size and thrust reduction portion length at least as long as set out in the following table for the nozzle size:

| Nozzle | Thrust reduction | Outlet |
|---|---|---|
| Size | portion length (mm) | Diameter (mm) |
| No. 3 | 17.5 | 10.0 |
| No. 4 | 23.0 | 13.0 |
| No. 5 | 29.0 | 16.5 |
| No. 6 | 34.5 | 20.0 |
| No. 7 | 40.5 | 23.0 |
| No. 8 | 46.0 | 26.5 |
| No. 10 | 57.5 | 33.0. |

69. (canceled)

70. The thrust reducer of claim 59, wherein the nozzle has a nozzle exit area to nozzle throat area ratio (A/A*) of 1.42±5%.

71. The thrust reducer of claim 70, wherein the nozzle comprises a nozzle with a nozzle size as set out in the leftmost column of the following table and the thrust reducer has a thrust reducer outlet diameter as set out in the following table for the nozzle size and thrust reduction portion length at least as long as set out in the following table for the nozzle size:

| | Outlet | Thrust reduction |
|---|---|---|
| Nozzle | Diameter | portion length |
| Size | (mm) | (mm) |
| No. 3 | 10.95 | 18.0 |
| No. 4 | 14.60 | 24.0 |
| No. 5 | 18.26 | 30.0 |
| No. 6 | 21.91 | 36.0 |
| No. 7 | 25.56 | 42.0 |
| No. 8 | 29.21 | 48.0 |
| No. 10 | 36.51 | 60.0. |

72. The thrust reducer of claim 59, wherein the nozzle has a nozzle exit area to nozzle throat area ratio (A/A*) of 2.1±5%.

73. The thrust reducer of claim 72, wherein the nozzle comprises a nozzle with a nozzle size as set out in the leftmost column of the following table and the thrust reducer has a thrust reducer outlet diameter as set out in the following table for the nozzle size and thrust reduction portion length at least as long as set out in the following table for the nozzle size:

| | Outlet | Thrust reduction |
|---|---|---|
| Nozzle | Diameter | portion length |
| Size | (mm) | (mm) |
| No. 3 | 13.32 | 78.5 |
| No. 4 | 17.76 | 104.5 |
| No. 5 | 22.20 | 130.5 |
| No. 6 | 26.64 | 157.0 |
| No. 7 | 31.08 | 183.0 |
| No. 8 | 35.52 | 209.0 |
| No. 10 | 44.40 | 261.0. |

74. The thrust reducer of claim 58, wherein the predetermined pressure range is 80 psi or greater and the nozzle has an A/A* area ratio of 1.63±5% and wherein the nozzle comprises a nozzle with a nozzle size as set out in the leftmost column of the following table and the thrust reducer has a thrust reducer outlet diameter as set out in the following table for the nozzle size and thrust reduction portion length ranging between the preferred length and the minimum length for effective thrust reduction as set out in the following table for the nozzle size:

| | Preferred | Preferred | Minimum Length for |
|---|---|---|---|
| Nozzle | Diameter | Length | effective thrust |
| Size | (mm) | (mm) | reduction (mm) |
| No. 3 | 11.8 | 37.5 | 23.5 |
| No. 4 | 15.7 | 50.0 | 31.0 |
| No. 5 | 19.6 | 62.5 | 39.0 |
| No. 6 | 23.5 | 75.0 | 46.5 |
| No. 7 | 27.4 | 87.5 | 54.5 |
| No. 8 | 31.3 | 100.0 | 62.0 |
| No. 10 | 39.2 | 125.0 | 77.5. |

75. The thrust reducer of claim 58, wherein the predetermined pressure range is 80 psi to 120 psi and the nozzle has an A/A* area ratio of 1.63±5% and wherein:
the nozzle comprises a #3 nozzle and wherein the length of the thrust reducer is between 7.5 mm and 67.5 mm and the diameter of the thrust reducer is between 10.00 mm and 13.5 mm; or
the nozzle comprises a #4 nozzle and the length of the thrust reducer is between 10.0 mm and 90 mm and the diameter of the thrust reducer is between 13 mm and 18 mm; or
the nozzle comprises a #5 nozzle and the length of the thrust reducer is between 12.5 mm and 112.5 mm and the diameter of the thrust reducer is between 12.5 mm and 22.5 mm; or
the nozzle comprises a #6 nozzle and the length of the thrust reducer is between 15 mm and 135.0 mm and the diameter of the thrust reducer is between 20 mm and 27.1 mm; or
the nozzle comprises a #7 nozzle and the length of the thrust reducer is between 17.5 mm and 157.5 mm and the diameter of the thrust reducer is between 23 mm and 31.5 mm; or the nozzle comprises a #8 nozzle and the length of the thrust reducer is between 20.0 mm and 179.5 mm and the diameter of the thrust reducer is between 26.5 mm and 36.0 mm; or the nozzle comprises a #10 nozzle and the length of the thrust reducer is between 25mm and 224.5 mm and the diameter of the thrust reducer is between 33.0 mm and 45.0 mm. Claims 76-82. (Canceled).

83. The thrust reducer of claim 57, wherein the thrust reducer body includes an inlet body portion that is removably received within the thrust reducer conduit of the thrust reducer body.

84. The thrust reducer of claim 83, wherein the inlet body portion comprises a removable sleeve that is removably received within the body.

85. The thrust reducer of claim 59, wherein the nozzle has a nozzle exit area to nozzle throat area ratio (A/A*) of between 1.42 and 2.1 and wherein:
the nozzle comprises a #3 nozzle and the thrust reducer has a thrust reducer outlet diameter of between 10 mm and 13.6 mm and a minimum thrust reduction portion length of between 7.5 mm and 78.5 mm; or
the nozzle comprises a #4 nozzle and the thrust reducer has a thrust reducer outlet diameter of between 12.4 mm and 18.1 mm and a minimum thrust reduction portion length of between 10 mm and 104 mm; or
the nozzle comprises a #5 nozzle and the thrust reducer has a thrust reducer outlet diameter of between 15.5 mm and 22.6 mm and a minimum thrust reduction portion length of between 12.5 mm and 130.5 mm; or
the nozzle comprises a #6 nozzle and the thrust reducer has a thrust reducer outlet diameter of between 18.5 mm and 27.1 mm and a minimum thrust reduction portion length of between 15 mm and 157 mm; or
wherein the nozzle comprises a #7 nozzle and the thrust reducer has a thrust reducer outlet diameter of between 21.7 mm and 31.6 mm and a minimum thrust reduction portion length of between 17.5 mm and 183 mm; or
the nozzle comprises a #8 nozzle and the thrust reducer has a thrust reducer outlet diameter of between 24.8 mm and 36.1 mm and a minimum thrust reduction portion length of between 20 mm and 209 mm; or
the nozzle comprises a #10 nozzle and the thrust reducer has a thrust reducer outlet diameter of between 31 mm and 45.2 mm and a minimum thrust reduction portion length of between 25 mm and 261 mm.

86-91. (canceled)
